(19) United States
(12) Patent Application Publication
(10) Pub. No.: US 2026/0280978 A1
(43) Pub. Date: Sep. 17, 2026

(54) SYSTEM AND METHOD TO CREATE AN ISOLATED HOSTING PLATFORM FOR DIGITAL ENTITIES

(71) Applicant: Huawei Technologies Co., Ltd., Shenzhen (CN)

(72) Inventors: Nimal Gamini Senarath, Ottawa (CA); Remziye Irem Bor Yaliniz, Ottawa (CA); Mohamed Faraj Moftah Alzenad, Ottawa (CA); Hang Zhang, Ottawa (CA)

(21) Appl. No.: 19/651,430

(22) Filed: Apr. 17, 2026

Related U.S. Application Data
(63) Continuation of application No. PCT/CN2024/098848, filed on Jun. 13, 2024.
(60) Provisional application No. 63/591,241, filed on Oct. 18, 2023.

(51) Int. Cl. H04L 41/0806; H04L 9/40; H04L 41/0895

(52) U.S. Cl. CPC H04L 41/0806; H04L 41/0895; H04L 63/0428

(57) ABSTRACT

Embodiments of the present application relate to a method, a network node, and a platform for creating a Hosting Platform (HOP) for Digital Entities (DEs) of real entities requiring privacy. In an example method, a Host Network (HN) can receive a request to host one or more DEs requiring privacy for the data associated with one of the one or more DEs or one of the real entities. In response to the request, a HOP is instantiated in a container of the HN. The HOP is configured with Hosting Platform Functions (HPFs) where at least some of the HPFs control access to DE data and/or DE applications to preserve its privacy.

### CROSS-REFERENCE TO RELATED APPLICATIONS

This application is a continuation of International Patent Application No. PCT/CN2024/098848, filed on Jun. 13, 2024, which claims the benefits of U.S. Provisional Application No. 63/591,241, filed on Oct. 18, 2023, the disclosures of which are hereby incorporated by reference in their entireties.

### TECHNICAL FIELD

The present disclosure pertains to a field of data communications and in particular to a system, a method and computer-readable medium to provide hosting platform to host digital entities in isolation.

### BACKGROUND

Public land mobile networks (PLMNs) are designed to provide connectivity services to users, and other types of entities, and their User Equipment (UEs). The concept of user-centric networks (UCNs) improves user network experience by dynamically adapting a network structure to individual user contexts.

Future networks may become more and more ‘user-centric’ as users or other types of entities require or demand more ownership and control over their services and their privacy, i.e., these future networks are expected to provide increased user empowerment. UCNs may be designed in a way for entities to have more control over services provided by a network or more control over the network providing these services to these entities.

Future networks must also be able to support new network infrastructure capabilities, suitable for cloud computing applications that are being deployed on a large scale. Future networks should be able to support the use of large-scale artificial intelligence (AI) models, data anonymization, blockchain technologies, etc., which have made significant progress in the last years.

In addition, future networks, including enhanced-5G and 6G networks, should also be designed to support new applications and services, including AI and data sensing services, which are widely used not only in industrial applications, but also by individuals. These applications enable more global and open collaboration between different entities, and future networks should be designed to provide or improve data confidentiality and reliability, standardization, and rapid application deployment.

As the real world is controlled more and more with the help of the digital realm, and as a more precise control over real-world systems is needed, digital twins have been created to provide digital representations of real-world entities. Those digital twins can represent any type of entity, including objects, such as engines, cars, robots; infrastructures, such as cities and factories, but also users themselves. Replicating users in the virtual world presents additional challenges compared to objects or infrastructures, as the confidentiality and integrity of user data is paramount.

All these factors are driving research of future network architecture, including, for example, 6G networks. Therefore, improvements in communication networks are desirable.

This background information is provided to reveal information believed by the applicant to be of possible relevance to the present disclosure. No admission is necessarily intended, nor should be construed, that any of the preceding information constitutes prior art against the present disclosure.

### SUMMARY

The present disclosure provides a Hosting Platform (HOP) that may allow instantiating and maintaining Digital Entities. Digital Entities may also be referred to as replicas or digital twins of real-word entities. A Digital Entity may comprise both the physical components (memory, processors, network cards, ports, etc.) and the software components required to enable the digital entity to communicate with other components, external or internal to the network hosting the digital entities.

In the present application, a Digital Entity, also referred to as DE, D-XX, DE module or D-XX module, corresponds to a representation of any entity, including, for example, assets, processes, systems, digital worlds, organizations, or users. A Digital Entity may be a virtual representation or replica of a real-world object, person or process that can be used to simulate their behaviors in order to better understand and predict their operation in real life. Digital Entities may be linked to real data sources, collected from sensors, and other information sources from their environment. The Digital Entities may be updated in real time to reflect the original, real-world versions. The Digital Entities may be interconnected and may communicate and influence one another such that entire systems may be replicated.

A Digital Entity replicating a physical entity or a collection of physical entities may be referred to as a Digital Representative (D-Rep or D-Rep module). A Digital Entity replicating a more complex system, such as an organization or a plant, and comprising several D-Reps, may be referred to as a Digital Infrastructure (D-Inf). Digital Entities replicating users, including for example animals and humans, can be referred to as D-Users.

Advantageously, a HOP can be created in a container of a Hosting Network and may be provided with different functions to create, store, maintain, and/or control the Digital Entities and/or provide services thereto. By isolating the HOP and its associated functions within a container, the privacy of the digital entities, along with the data linked to them, and ultimately the users who control these digital entities, can be preserved. The proposed HOP may efficiently instantiate Digital Entities when requested and may comprise functions required securely and privately interface the Digital Entities with external devices via the Hosting Network.

Network operators may be provided with different options to instantiate and configure the HOP, including configuring the HOP for a single digital entity, for example a single D-Rep platform, or for multiple entities, for example as multi-D-Rep platform. When the Digital Entity is a replica of a user, the HOP can be configured for a single D-User or for multiple D-Users, as a multi-D-User platform. The HOP can be instantiated and maintained as an isolated function module within the hosting network.

The Hosting Network (NH) may function as either a trusted or untrusted environment for the Digital Entities. For an untrusted network, methods to prevent the Hosting Network from accessing the data or operations related to the Digital Entity (referred to as DE data) and/or applications executed or accessed by the Digital Entity (referred to as DE applications) are proposed. Methods are also proposed to prevent the Hosting Network from acquiring information on external servers accessed by the Digital Entities.

According to an aspect, a method is provided for creating an isolated Hosting Platform (HOP) for Digital Entities (DE or D-XX) of real entities. The method may comprise receiving at a Hosting Network Function (HNF) of a Host Network (HN) a request to create a HOP to host one or more DEs for DE data and DE applications associated therewith. In response to the request, a HOP may be created or instantiated in a container inside the HN. The HOP may include or may be configured with Hosting Platform Functions (HPFs).

In possible embodiments, DE data may comprise parameters defining the DE as an entity and operational data associated with operations performed by the DE applications executed by the one or more DE. The DE applications may comprise at least one of: home network applications, AI schemes, user health applications, Virtual Reality (X-R) applications, infrastructure management applications, traffic control applications, data filtering and data processing.

The real entities represented by the DEs may comprise one of physical processing devices, physical users (P-Users); P-User access device (UAD); organizations; infrastructures; buildings, one or more network functions, application servers; User Equipment (UE); UE sensors; and user applications.

In possible embodiments, each of the DEs may comprise DE Functions. The HPFs and/or the DE Functions may be accessible to the real entities without awareness of the HN. The DE functions may comprise DE Network Functions, including DE Management Plane Functions, DE Control Plane Functions and DE Data Plane Functions. DE Data Plane Functions may correspond to functions which process data received according to certain processing specifications and forward the data to a specified destination. DE Data Plane Functions may also forward input traffic to a given destination according to the destination information included in the data packets.

In possible embodiments, preserving privacy of the real entity may be performed by the HPFs, for example by preventing visibility of: real entity and/or DE data, processing of the real entity data and/or DE data, or of execution of specific functions of the real entity from any other entity using the Hosting Network or from any other external networks. The external networks may also host external DEs and/or HNFs.

In possible embodiments, the request may be received from one of a real or physical users (P-Users), a DSMF (management plane function), a HPF, a DE provider, the P-User access device (UAD) or the User Equipment (UE).

In some embodiments, access to the DE Functions is executed by the one or more DEs is controlled by the HNF. The DEs may represent real entities such as robots, buildings or organizations are referred to as Digital Representatives (D-Reps) and the DEs representing humans are referred to as Digital Users (D-Users).

In some embodiments, the parameters defining the D-Users may comprise at least one of: age, name, gender, address, physical and/or behavior characteristics, location, preferences, physiological data, the user context, environmental context, mobility, past activities.

In some embodiments, operational data defining operations performed by functions of the one or more DEs may comprise one or more of: processing of input data; modifying input data; forwarding input data or processed data to a specified destination; deleting input data; creating and managing life cycle (LCM); and resource assignment of other functions.

In some embodiments, the HOP corresponds to at least one of: a single D-User platform, a multiple D-User platform, a Network for Digital World (NET4DW) platform and an isolated function module. In some embodiments, the Host Network (HN) is one of: a Wifi Network, a Radio Access Network (RAN), a Core Network (CN) or a Data Network (DN). In some embodiments, the HN is trustable by the entity associated with the corresponding DE.

In some embodiments, the at least one HNF facilitates access of the one or more DEs to access external servers anonymously by executing IDentification Management Functions (IDMF) which change source IDs and/or response addresses associated with the one or more DEs.

In some embodiments, at least one HNF processes the DE data inside the HOP by performing Data Processing Functions (DPF) inside the HOP. In some embodiments, access to HNFs inside the HOP is controlled using a gateway (GW) in a Control and Management Plane (C/M plane) of the HN, and a GW in a Data Plane (DP) of the HN.

In some embodiments, at least one HPF prevents the HN from accessing the DE data when the DE processes DE data inside the HOP or when the DE shares DE data with other entities external to the HN.

In some embodiments, the at least one HPF prevents the HN from accessing the DE data by having the container instantiated in a Trusted Executive Environment (TEE), corresponding to a confidential computing environment (CCE) located inside the HN, the container being isolated from operating systems (OSs) of the HN.

In some embodiments, the at least one HPF prevents the HN from tracking which external servers the DE has accessed by instantiating the HOP as a multiple DE-HOP comprising a plurality of DEs.

In some embodiments, the at least one HPF prevents the HN from accessing operations performed by the one or more DEs inside the HOP by performing all DE Functions inside the multiple DE-HOP, wherein the multiple DE-HOP is attributed a separate slice of the HN.

In some embodiments, the HOP is preconfigured to create the Hosting Platform Functions (HPFs) inside the TEE and to interact with the one or more DEs therein.

In some embodiments, the container is an isolated container executed on hardware that is managed and controlled by the HN.

In some embodiments, the container is protected by a cryptographic key, isolating the container from the Operating System (OS) managing the TEE, the cryptographic key being required to access the DE hosted in the HOP in the container.

In some embodiments, the method comprises receiving, at the container, an attestation request by a remote device and providing, by the container, the cryptographic key to the remote device based on a unique identifier of the content or the functionality of the container, to attest authenticity of the container.

In some embodiments, the DE is a digital representative (D-User) of a physical user and the remote device is a User Equipment (UE) of the physical user.

In some embodiments, the User Equipment (UE) verifies the authenticity of the container by providing the cryptographic key to an external device, the external device providing at least one of the container, content inside the container and functionalities of the container.

In some embodiments, integrity of the HOP, of the DE hosted inside the HOP and of the DE applications executable inside the DE are standardized and certified by remote attestation entities, and verifiable using certified signatures thereof.

In some embodiments, instantiating and configuring the HOP is performed by a HOP Creation and Configuration Function (HPCCF), which performs one or more of: creating the HPFs in the container; providing interfaces for the HPFs; managing resources of the HPFs relating to storing, processing and communications; and performing Life Cycle Management (LCM) of the HPFs inside the container according to a set of instructions.

In some embodiments, different types of HOPs are associated with corresponding HOP blueprints, the HOP blueprints being stored in a Blueprint Description Repository (BDR) of the HN.

In some embodiments, the LCM instructions for the HPFs are provided as part of the HOP blueprint.

In some embodiments, the HOP blueprint comprises at least one of: a description of the HPFs, interfaces of the HPFs, procedural instructions, configuration attributes, and descriptions or blueprints of the DEs supported.

In some embodiments, the HPFs comprises a HOP Manager Function (HMF) created inside the HOP, the HMF performing Life Cycle Management (LCM) of the one or more DEs, and managing communications between the DEs and other entities.

In some embodiments, the HMF further performs downloading, installing, and configuring the DE applications accessible to the one or more DEs or/and User Equipments having access to the one or more DEs.

In some embodiments, the one or more DEs are created in the HOP by the HMF based on DE blueprints, the DE blueprints comprising at least one of: creation instructions of the DEs, LCM of the DEs, operation of the DE modules, resource requirements, and Quality of Service (QoS) for messaging to and from the Hosting Platform Functions (HPFs).

In some embodiments, the method further comprises the HNF or/and HPFs identifying privacy levels required by the one or more DEs and the HPFs implementing privacy techniques associated with the privacy levels.

In some embodiments, the privacy techniques comprises at least one of changing an identifier of DEs when interacting with external entities, encrypting the DE data exiting the HOP, preventing a given DE from accessing data and internal functions of another DE without authorization from the other DE, facilitating communications among the DEs including using discovery methods, authentication methods and an authorization methods, preventing the HN or HNF from accessing the DE data inside the HOP, preventing the HN or HNF from accessing HPFs without authorization from the HPF responsible for access control and providing a random location inside the HOP for external entities to provide responses to requests from the DEs.

In some embodiments, the HMF is adapted to instantiate portals when requested by a Control Plane Functions (CPFs) or a D-Rep Service Manager Function (DSMF) of the HN.

In some embodiments, the request to HNF for the one or more DEs comprises a request for a XaaS (Anything as a Service) Function.

In some embodiments, instantiating and configuring the HOP by the HPCCF is done using a Hosting Platform Installer Function (HPIF).

In some embodiments, the request is received from one of a real or physical users (P-Users), a Service Management Function (SMF), a HPF, a DE provider, the P-User access device (UAD) or the User Equipment (UE).

In some embodiments, the one or more DEs comprises a D-User, at least one function inside the D-User is controlled via a User Equipment (UE) of a physical user and wherein at least one function inside the one or more DEs provides services to the physical user.

In some embodiments, one of the HPFs comprises a HOP Function Orchestrator (HFO) to instantiate additional HPFs inside the HOP.

In some embodiments, the HMF establishes secure communication with the HNFs, including at least one of: Hosting Platform Control and Configuration Platform Function (HPCCF), DE Creation Function (DXCF), and DE service manager (DSMF).

In some embodiments, the HMF proceeds with a discovery process comprising: determining messaging structure, using ingress and egress ports to access the HN C/M and DP bus.

In some embodiments, the method further comprises determining a type of HOP that is to be instantiated, based on at least one of: DE type and associated DE services to be included and provided thereto; requirement of the DE for a trusted or untrusted network; and level of privacy required for an untrusted network.

In some embodiments, instantiating the HOP comprises sending a message to an Infrastructure Service Management Function (ISMF) specifying at least one of: a HOP category, requirements for a TEE, requirements for the HOP, requirement for the DEs to be hosted therein and the blueprints for the HOP and for the DEs.

In some embodiments, the ISMF requests the Hosting Platform Creation and Configuration Function (HPCCF) creation of the HOP, based on the HOP blueprint.

In some embodiments, the HPCCF verifies availability of the HOP blueprint from a Blueprint Repository Management Function (BRMF).

In some embodiments, the HPCCF prepares final HOP blueprints matching the HOP requirements.

In some embodiments, the HOP Installation Function (HPIF) creates the HOP, instantiate initial HPFs and interfaces required by the HOP.

In another aspect, there is provided a tangible, non-transitory memory having recorded thereon instructions to be carried out by one or more processors to carry out a method as defined in any one of the methods described herein.

In another aspect, there is provided a network node, the network node being part of the Host Network, the network node comprising: a processor; and a tangible, non-transitory memory as defined above.

In another aspect, there is provided an isolated Hosting Platform (HOP) for Digital Entities (DEs) digitally replicating real entities, comprising a Control and Management (C/M) plane function module. The C/M comprising at least one of: a C/M gateway for controlling incoming and outgoing messages of the C/M plane functions module; a C/M plane privacy preserving portal (PPP); a HOP manager function (HMF); a HOP internal function orchestrator (HFO); Common C/M network functions (NFs) for supporting DE module operations; and a Data Plane (DP) functions module. The DP functions module comprising at least one of: a common database, a PPP and Hosting Platform Functions (HPFs) to support DE operations.

In another aspect, there is provided a system allowing a Host Network (HN) to provide a confidential digital environment to a real entity for applications thereof, the system comprising one or more processors a tangible, non-transitory memory storing instructions executable by the one or more processors to: provide a Hosting Platform (HOP) in a container of the HN, the HOP being created, configured and managed by the HN; the HOP being configured to allow the real entity to create a digital entity (DE) representing the real entity inside the HOP upon receiving a request from the real entity; the DE comprising at least one DE function and corresponding resources to execute the at least one DE function; and the HN controlling and managing communications between the DE and the physical entity, and between the DE and other entities external to the HN to ensure privacy of the communications.

In some embodiments, the real entity can execute the at least one DE function, execution of the at least one DE function being private and not visible to the HN.

In some embodiments, the container in which the HOP is provided is a Trusted Execution Environment (TEE).

In some embodiments, the Trusted Execution Environment (TEE) provides remote attestation to the physical entity to ensure integrity of the TEE.

In some embodiments, execution of the at least one DE function is private and protected from the physical entity.

According to another aspect, there is provided an apparatus, wherein the apparatus comprises a processor and a memory storing one or more instructions that is capable of being run on the processor, and when the one or more instructions are run, the apparatus is enabled to perform any of the methods described herein.

According to another aspect, there is provided an apparatus, wherein the apparatus comprises a function or unit to perform any of the methods described herein.

According to another aspect, there is provided a computer readable storage medium, comprising one or more instructions, wherein when the one or more instructions are run on a computer, the computer performs any of the methods described herein.

According to another aspect, there is provided a non-transitory computer-readable medium storing instruction the instructions causing a processor in a device to implement any of the methods described herein.

According to another aspect, there is provided a device configured to perform any of the methods described herein.

According to another aspect, there is provided a processor, configured to execute instructions to cause a device to perform any of the methods described herein.

According to another aspect, there is provided an integrated circuit configure to any of the methods described herein.

A function may be referred to as a functional block of code executable by one or more processors, within a network architecture, with predefined external interfaces and behavior, to receive, process and transmit data packets.

Hosting Network Functions (HNFs) may comprise functions that are controlled and managed by processing devices of the Hosting Network (HN) to provide services to end users, to HOPs, and to Digital Entities, including end-user devices or equipment (UE) and/or end user applications.

In the context of the present application, HNFs may include, as examples only, a Hosting Platform Creation, an Infrastructure or XaaS service management function (ISMF), and Configuration Function (HPCCP) and Hosting Platform Installer Function (HPIF).

Hosting Platform Functions (HPFs) comprises functions that are provided for or by the HOP, such as to create, control and manage Digital Entities inside the HOP. In the context of the present application, HPFs can include as examples only a Hosting Platform Management Function (HMF) and a Privacy Preserving Portal (PPP). HOP Network Functions may include Control and Management Network Functions, and Data Plane Network Functions.

In possible embodiments, the method and system may allow creating the HOP for hosting Digital Entities (DE or D-XX), or replicas, of real-world entities requiring privacy, such as users, when the physical entities use the network services provided by the HN. The network services may comprise executing applications related to the entities, processing data for the entities, carrying out analysis or simulations for the entities, controlling equipment and providing communications between entities and external devices or functions inside the digital entities (DE/D-XX), such as D-Reps and/or D-Users.

In possible embodiments, the HOP may be configured with at least one Hosting Platform Function (HPF) inside the HOP. The HPF can perform one or more of: creating additional HPF inside the HOP; creating the Digital Entities inside the HOP; controlling access to the Digital Entities and/or HPFs; carrying out Life Cycle Management (LCM) for the Digital Entities and/or HPFs; resource management of the HPFs and/or the Digital Entity module; configuration of the HPFs and Digital Entity modules; facilitating communication with the external and internal HOP entities for the HPFs and/or the Digital Entity modules; supporting the Digital Entity operations and/or for the one or more Digital Entity hosted in the HOP.

The request for a Digital Entity may be made by a physical entity to obtain one or more network services from the HN. A HNF may provide an HPF with the information provided by the physical entity regarding the Digital Entity requirements, such as privacy requirements and services, and either the HPF or/and the HNF proceeds with creating the Digital Entity with the configurations required to provide the one or more network services. Creating the Digital Entity may comprise the creation of a secure communication link between the physical entity and a Digital Entity, for allowing the physical entity or the Digital Entity to obtain the network services.

In possible embodiments, the container, the internal functions of the container, and the Digital Entity can be created using resources of the HN. In this case, the HPFs can be created and managed by the HNFs.

In possible embodiments, the container, the internal functions of the container and the Digital Entity/ies may be created and executed in an enclave, or Trusted Execution Environment (TEE), of one or more processors of a node in the NH. The TEE may correspond to a confidential computing environment (CCE) inside an Operating System, which can be provided by a TEE provider.

In the context of the present application, the TEE may be provided with blueprints of the HOP, which defines internal HOP functions (HPFs) and also possibly the Digital Entities to be instantiated inside the HOP.

In one embodiment, access to functions inside the TEE can be provided to the HNF to carry out a limited number of operations using the HPFs. These limited number of operations may be performed by certified functions and programs required to establish communication links and configurations needed to give the Digital Entity benefit the network services. Therefore, a HNF may request a HPF to create a Digital Entity and establish secure communications between the Digital Entity and the associated real or physical entity so that the real-world entity can obtain network services while preserving privacy. The physical entity may be owned or controlled by an end user, e.g., the physical entity can correspond to the equipment used by the end user to access the Hosting Network. The physical entity may obtain credentials of the Digital Entity (for example a D-Rep) and may carry out a remote attestation with the TEE provider to ensure that the HN does not have access to the D-Rep data or to the D-Rep application, or that the HN is not aware of the operations being executed by the D-Rep.

Digital Entity data may comprise or be defined by parameters characterizing the Digital Entity as an entity and operational data associated with operations performed by the Digital Entity applications executed by the one or more Digital Entities. The Digital Entity applications may include at least one of: home network applications, AI schemes, user health applications, Virtual Reality (X-R) applications, infrastructure management applications, data filtering and data processing.

According to an aspect, a tangible, non-transitory memory is provided, having recorded thereon instructions to be carried out or executed by one or more processors, to perform the method as defined above.

According to another aspect, a network node of a hosting network is provided. The network node comprises one or more processors; and one or more tangible, non-transitory memories as defined above. A network node may refer to any device or point within a communication network that can send, receive, process or forward data. Network nodes may include devices such as computers to more complex equipment such as routers, switches, and servers.

According to another aspect, an isolated Hosting Platform (HOP) for Digital Entities is provided. The HOP may comprise a Control and Management (C/M) plane functions module. The C/M plane function module may comprise at least one of: a C/M gateway for controlling incoming and outgoing messages of the C/M plane functions module; a C/M plane privacy preserving portal (PPP); a HOP manager function (HMF); a HOP internal function orchestrator (HFO); Common C/M network functions (NFs) for supporting Digital Entity module operations. The HOP module may also comprise a Data Plane (DP) function module comprising at least one of a common database, a Privacy Preserving Portal (PPP) and Hosting Platform Functions (HPFs) for supporting Digital Entity operations.

According to another aspect, a system for allowing a network to provide a confidential digital environment to a physical entity for applications is provided. The network may be a network provider, such as a Mobile Network Operator (MNO). The physical entity may be any processing device associated with a physical entity, such as a phone, a computer, a car. The physical entity may be provided with processor(s), memory and communications means. The system may comprise one or more processors, and tangible, non-transitory memory storing instructions executable by the one or more processors. The system may provide or create a Hosting Platform (HOP) in a container of the network. The HOP may be created, configured and managed by the network. In other words, the Life Cycle Management (LCM) of the HOP may be performed by the network. The HOP may be configured to allow the physical entity to create a Digital Entity associated with the real-world entity inside the HOP upon receiving a request from a physical entity. The Digital Entity may comprise at least one Digital Entity function or application and corresponding resources, within the HOP, to execute the at least one Digital Entity function. The network may control and manage communications between the Digital Entity and the physical entity, and between the Digital Entity and other entities external to the network. The physical entity may execute functions or applications of the Digital Entity and execution thereof is private and protected from the network. The container in which the HOP is provided may be a Trusted Execution Environment (TEE), which may be provided with attestation features.

Other features, aspects, and advantages of the present disclosure will become more apparent upon reading of the following non-restrictive description of specific embodiments thereof, given by way of example only with reference to the appended drawings. Although specific features described in the foregoing summary and in the following detailed description may be described with respect to specific embodiments or aspects, it should be noted that these specific features may be combined with one another unless explicitly stated otherwise herein.

### BRIEF DESCRIPTION OF THE DRAWINGS

FIG. 1 shows a block diagram of a UE, 3GPP network elements and a data network interconnected through VUE interfaces, in accordance with embodiments of the present disclosure.

FIG. 2 shows a possible architecture of a network for a digital world, in accordance with embodiments of the present disclosure.

FIG. 3 shows a schematic illustration of a communication system, in accordance with possible embodiments of the present disclosure.

FIG. 4 shows a schematic illustration of a communication system, in accordance with other possible embodiments of the present disclosure.

FIG. 5 shows a schematic illustration of an electronic device and of a base station, in accordance with possible embodiments of the disclosure.

FIG. 6 shows a schematic illustration of modules of an electronic device, in accordance with possible embodiments of the disclosure.

FIG. 7 shows a block diagram of a network system, in accordance with possible embodiments of the present disclosure.

FIG. 8 shows a HOP high-level architecture, including the instantiated D-User modules, in accordance with possible embodiments of the present disclosure.

FIG. 9 shows an exemplary system architecture including a Hosting Platform (HOP) and HOP creation functions, in accordance with embodiments of the present disclosure.

FIG. 10 is a flow chart of the HOP creation process at high level, according to a possible embodiment.

FIG. 11 is a diagram showing a HOP functional architecture including D-User creation functions, according to a possible embodiment.

### DETAILED DESCRIPTION OF ILLUSTRATIVE EMBODIMENTS

### 6.1. Disclaimers and Term Interpretation

In the following description and figures, same reference numbers refer to similar elements of the application. Furthermore, to not unduly clutter the figures, it is possible that a figure may not contain all the reference numbers of the elements found in the figure. It is also possible that some elements or components may be referenced in only one figure. The element thereby referenced can easily be inferred in the other figures shown. The embodiments, geometrical configurations, materials and/or dimensions shown in the figures or described in the present disclosure are only indicative, and show possible embodiments, presented as examples, and should not be interpreted as limiting the application.

One or more systems described herein may be implemented in computer programs executing on processing devices, each comprising at least one processor, a data storage system (including volatile and non-volatile memory and/or storage elements), at least one input device, and at least one output device. The term “processing device” encompasses computers, servers and/or specialized electronic devices which receive, process and/or transmit data. “Processing devices” are generally part of “systems” and include processing means, such as microcontrollers and/or microprocessors, CPUs or are implemented on FPGAs, as examples only. For example, and without limitation, the processing device may be a programmable logic unit, a mainframe computer, server, a personal computer, a cloud-based program or system, a laptop, a personal data assistance, a smartphone, a wearable device, or a tablet device.

Each program is preferably implemented in a high-level procedural or object-oriented programming and/or scripting language to communicate with a computer system. However, the programs can be implemented in assembly or machine language, if desired. In any case, the language may be a compiled or interpreted language. Each such computer program is preferably stored on a storage media or a device readable by a general or special purpose programmable computer for configuring and operating the computer when the storage media or device is read by the computer to perform the procedures described herein. In some embodiments, the system may be embedded within an operating system running on the programmable computer.

Furthermore, the system, processes and methods of the described embodiments are capable of being distributed in a computer program product comprising a computer readable medium that bears computer-usable instructions for one or more processors. The computer-usable instructions may also be in various forms including compiled and non-compiled code.

The processor(s) are used in combination with one or more storage medium, also referred to as “memory” or “storage means”. Storage medium can store instructions, algorithms, rules and/or trading data to be processed. Storage medium encompasses volatile or non-volatile/persistent memory, such as registers, cache, RAM, flash memory, ROM, diskettes, compact disks, tapes, chips, as examples only. The type of memory may be chosen according to the desired use, whether it should retain instructions, or temporarily store, retain or update data. Steps of the proposed method are implemented as software instructions and algorithms, stored in computer memory and executed by processors.

The terms “a”, “an” and “one” are defined herein to mean “at least one”, that is, these terms do not exclude a plural number of items, unless stated otherwise. In the present disclosure, “at least one” means one or more, and “a plurality of” means two or more. “and/or” describes an association relationship of associated objects, and indicates that there may be three relationships. For example, A and/or B may indicate cases includes “only A”, “both A and B”, and “only B”, where A and B may be singular or plural. The character “/” generally indicates that the associated objects are in an OR relationship. “At least one of the following items” or a similar expression thereof refers to any combination of these items, including any combination of a single item or a plurality of items. For example, “at least one of a, b, or c” may represent a, b, c, “a and b”, “a and c”, “b and c”, or “a, b and c”, where a, b, and c may be a single or multiple form.

Terms such as “substantially”, “generally” and “about”, which modify a value, condition or characteristic of a feature of an exemplary embodiment, should be understood to mean that the value, condition or characteristic is defined within tolerances that are acceptable for the proper operation of this exemplary embodiment for its intended application.

Unless stated otherwise, the terms “connected” and “coupled”, and derivatives and variants thereof, refer herein to any structural or functional connection or coupling, either direct or indirect, between two or more elements. For example, the connection or coupling between the elements can be acoustical, mechanical, optical, electrical, thermal, logical, or any combinations thereof.

Expressions such as “match”, “matching” and “matched”, including variants and derivatives thereof, are intended to refer herein to a condition in which two or more elements are either the same or within some predetermined tolerance of each other. That is, these terms are meant to encompass not only “exactly” or “identically” matching the two elements but also “substantially”, “approximately” or “subjectively” matching the two or more elements, as well as providing a higher or best match among a plurality of matching possibilities.

In the present description, the expression “based on” is intended to mean “based at least partly on”, that is, this expression can mean “based solely on” or “based partially on”, and so should not be interpreted in a limited manner. More particularly, the expression “based on” could also be understood as meaning “depending on”, “representative of”, “indicative of”, “associated with” or similar expressions.

The present disclosure encompasses various embodiments, including not only method embodiments, but also other embodiments such as apparatus embodiments and embodiments related to non-transitory computer readable storage media. The embodiments may incorporate, individually or in combinations, the features disclosed herein.

Although this disclosure refers to illustrative embodiments, this is not intended to be construed in a limiting sense. Various modifications and combinations of the illustrative embodiments, as well as other embodiments of the disclosure, will be apparent to persons skilled in the art upon reference to the description. Features disclosed herein in the context of any particular embodiments may also or instead be implemented in other embodiments. Method embodiments, for example, may also or instead be implemented in apparatus, system, and/or computer program product embodiments. In addition, although embodiments are described primarily in the context of methods and apparatus, other implementations are also contemplated, as instructions stored on one or more non-transitory computer-readable media, for example. Such media could store programming or instructions to perform any of various methods consistent with the present disclosure.

### 6.2. User Equipment (UE) and Virtual User Equipment (VUE)

In the context of the present disclosure, the term ‘UE’ may represent a combination of a network access device (NAD) and a user personal device (UPD). Also, in the context of the present disclosure, a VUE is a digital entity located in the network and represents both the NAD and the UPD. UCM services may be provided by deploying the VUE by at least one network node of the network. The user applications and user data can be considered as higher layer components of the UE. These higher layer components may be considered to be the UPD. The UE can use its applications in the NAD to facilitate UCM services. A VUE may have different functionalities depending on the UCM service types it provides. In the context of the present disclosure, the term VUE type is a VUE having functionalities that can provide specific types of UCM services. The VUE may be deployed at different segments of the network (e.g., RAN, CN, mobile edge computing node (MEC), etc.) in a hierarchical manner to support various UCM services for UEs. The VUE may represent a particular UE and facilitate certain actions on behalf of the UE to support applications and services engaged throughout the network. There may be different types of VUEs providing different types of UCM services. Not all UEs may require user empowerment and therefore, a VUE or a UCM service may be provided as an add-on feature to the UE. A UE, requiring a particular UCM service, may have to subscribe to a particular VUE type or a UCM service (a VUE type may be configured to provide multiple UCM services). Subscription may be done by the UE contacting the mobile network operator's (MNO's) service desk or through an application provided in the UE, in which case the UE may send a special request to the network. The network may request a VUE creation function (VUCF) in the network to instantiate the VUE. Instantiation of the VUE may include the instantiation of at least one NF belonging to the VUE and its required interfaces. In one embodiment, the instantiation of the VUE may include the instantiation of a VUE-M (VUE manager) which has the capability of instantiating other NFs and interfaces belong to the VUE. There may be multiple VUEs located in different parts of the network (e.g., in different parts of a 3GPP network) and in data networks (DNS). In some embodiments the VUE creation request may be made by another, already existing, VUE. In some embodiments, instantiating the VUE may include instantiating NFs and respective interfaces associated with a VUE type.

When a VUE is created (generated) it may be created with a VUE-Manager (VUE-M), other Network Functions (i.e., UPFs and CPFs) and a database. Creation of the VUE may include engagement of a virtualized infrastructure and a VUE-M. The VUE-M may use the virtualized infrastructure to instantiate the other network functions and the interfaces, necessary for the requested VUE type. The infrastructure may be part of the hosting network, or it may be a hardware platform provided by a third party vendor, as a trusted executive environment. In some embodiments, instantiating the VUE may include instantiating NFs and respective interfaces associated with a VUE type.

The VUE instantiation may include instantiation of functions together with interfaces required for the requested UCM features in the network, which may be a wireless network. With the required interfaces in place, the VUE may interact with the network on behalf of the UE to engage the requested UCM features without direct interaction between the UE and the functions in the access network, for example, over an air interface when the UE is a wireless device.

### 6.3. X-centric Network Architecture

Many new trends trigger considerations and design of 6G or future wireless networks, including: new network infrastructure capability, e.g., cloud natured/friendly infrastructures that are broadly deployed; new relatively matured techniques, e.g., AI large-scale models, data de-privacy, block chain, etc. that have made significant progress and significantly impact on the entire society and human life; new apps and services, e.g., AI services, Data (sensing) services, digital world services, etc. that are broadly applied in industry/business and used by individual customers; more global, open and collaborative operation trends, i.e., a more open and more collaborative operation mode is becoming common practice in many fields. New expectations and stricter requirements on future networks also drive rethinking and development of new generations of wireless networks. These requirements may include: increased privacy and trustworthiness, simplified standardization of data and exchanges, rapid deployment of digital environments.

The proposed network architecture described herein, which may apply to 6G networks, is an X-centric architecture, which means that is it centered on objects and users, and is therefore a cloud-native, Service Based Architecture (SBA), to support the delivery of services for different types of entities, where any object or entity may be provided as a service.

Consequently, the proposed network architecture, which may be adapted to, for example 6G networks, may support new services which can be developed or deployed by 3rd parties. The proposed network architecture can be adapted to allow communications and exchanges with technical capable 3rd parties, and may be adapted to enable trustworthiness management.

### 6.4. D-User as Digital Representative of a User

In the context of the present disclosure, a Virtual User, also referred to as a D-User or D-User module, is a digital representative of a user instantiated and maintained inside a network, which becomes a “hosting network”. A D-User is a special case of a Digital Entity (DE or D-XX). Since one or more D-Users may be stored and maintained inside the hosting network, a D-User can closely interact with the hosting network and/or other digital entities maintained in the hosting network, in order to provide the “real” user with more control over services obtained from the hosting network, i.e., the D-User may allow for improved user empowerment. The network services may be provided by the hosting network as added services and may be referred to as User Controlled and Managed (UCM) services. In possible embodiments, a D-User module may be a standalone code section or segment that includes different functions and routines, or that provide different services, according to a predetermined structure.

There may be different levels of control and management given to a user, i.e., empowerment levels. An empowerment level refers to the degree of authority, autonomy, and control granted to a user. The present disclosure provides different empowerment levels, including, for example:
User-defined service capability, i.e., user may define the services the user needs;
User may manage/control behaviors or features of the services provided by the hosting network;
The hosting network may be designed such that each user is served with a specific part of the network (e.g., exclusive logical slice) and have a certain control on it;
Services may be provided considering the user's context (e.g., user in the loop, user context is used for dynamic network functionality/operation modifications);
User device(s)/networks may become part of the network, e.g., UE as BSs/relays, drone BSs/relays, application servers;
User becomes a producer/provider of services to the network, e.g., AI service, neighbour information, video services, BS service provided by a user device or drone BS;
A D-User inside the network can interact with the hosting network to provide or facilitate these services. For this purpose, the D-User may include control plane functions, user plane functions, data storage, and required internal and external interfaces.

### 6.5. User Equipment, 3GPP Network and Data Network

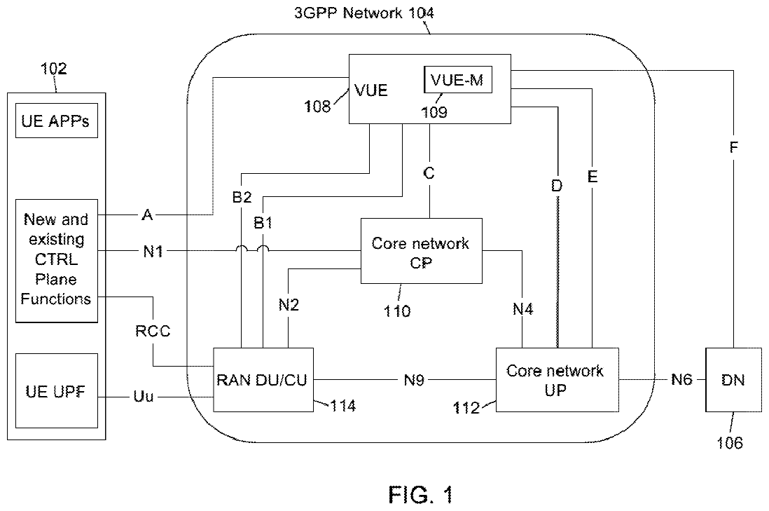

FIG. 1 illustrates an example of interfaces of a D-User.

FIG. 1 shows a block diagram of a UE 102, a communications network (e.g. a 3rd Generation Partnership Project (3GPP) network) 104 and a data network (DN) 106 interconnected to each other through VUE interfaces (also referred to as reference points), in accordance with embodiments of the present disclosure. The network 104 may include a VUE 108, a VUE-M 109, a core network (CN) control plane (CP) 110, a core network user plane (UP) 112 and a RAN distributed unit (DU)/central unit (CU) 114. In the embodiment of FIG. 1, VUE operations may require several control plane and data plane interfaces between the UE 102 and elements of the network 104, and between elements of the 3GPP network 104 and the DN 106. The required interfaces may depend on the type of UCM services, facilitated by the VUE. A given interface may be used only by some UCM services. In addition to the interfaces that are defined in 5G standards, additional interfaces or additional messaging over the existing interfaces may be required for VUE deployment and operation. Several interfaces may be required for operation of the VUE 108. In the context of the present disclosure, an interface may be referred to as a reference point and vice versa.

VUE-UE control plane reference point (A)—Interface A shown in FIG. 1 is mainly for UE to VUE control plane messaging, transparent to the network. The interface A may be configured to synchronize, between the UE 102 and the VUE 108, the UE data (e.g., UE context, location), to provide authentication, authorization, and information in relation to the connections between the VUE and UE, data packet formats and any new UCM protocol data unit (PDU) session initialization. Depending on the UCM service, synchronization of a high-volume data flow may require a logical data plane connection between the UE 102 and the VUE 108. The data plane connection may be established by the network, for example, via a Uu interface and a B2 interface, in response to a request from the VUE 108 or the UE 102. For this purpose, the UE 102 may send control plane messages to the VUE 108 through the VUE-UE control plane reference point A interface. NFs in the network (or at least one NF in the network) may be configured to interact with the UE to obtain a user context.

VUE-RAN control plane interface (B1)—Interface B1 is used for certain UCM services such as, for example, when the VUE 108 requires specific radio access network (RAN) technologies or features. The VUE 108 may use this reference point to make such requests. In addition, this logical link (interface B1) may be used for direct UE functionality authentication, which is similar to access and mobility-management function (AMF) functionality.

VUE-RAN data plane interfaces (B2)—For some UCM applications, interface B2 may be used to direct UE traffic to and from the VUE 108, transparent to the hosting network (Core Network or RAN). The N9 and N4 reference points may be used for the same purpose.

VUE-CN control plane reference point I—The CN CP 110 may have a single entry reference point (interface C) to a VUE control plane engaged to set up connections, authentication, authorization and accounting (AAA), policy update handling and lifecycle management of network functions at the VUE 108.

VUE CPF—CN UPF reference point (D) interface—Interface D is used by certain types of UCM services that enable VUE CPFs to control CN UPFs for routing and data processing purposes if the network operator allows certain level of control on certain UPFs. The D reference point interface may also be used for monitoring UE traffic-related information (e.g., resource usage, quality of experience (QoE), different flows routing to different processing functions, UPFs or DNs). NFs in the network (or at least one NF in the network) may be configured to obtain the user traffic/data for internal processing.

VUE-CN data plane reference point I interface—Interface E is for UCM services when there is a requirement for certain data processing at the VUE 108 or when certain data has to be terminated or started at the VUE 108. In this case user traffic originated by the UE 102 or the DN 106 is diverted to the VUE 108 using this interface. NFs in the network (or at least one NF in the network) may be configured to obtain the user traffic/data for internal processing.

VUE-DN data plane reference point (F) interface—Interface F is to send and receive data directly between the VUE 108 and DN 106. The interface is required only for certain UCM services.

There are numerous options for defining reference points for interactions between different VUE control plane functions (CPFs) and different CN CPFs. For example, a standard may define a number of reference points for the interactions between a specific VUE CPF to a specific CN CPF. It is also possible that a single reference point may be defined for all control plane communications between the VUE 108 and each network domain (e.g., VUE or CN).

In addition to already described reference points, a number of 5G network reference points (e.g., in 23.501, 3GPP), for example, N1 and N2, may have to be modified to include UCM functionality and support required messaging for the VUE 108 and for UCM services.

N1 reference point between the UE 102 and an access and mobility management function (AMF). In addition to the relevant functions defined in the 3GPP TS 23.501 standard for this reference point, to support a VUE or a UCM service, the N1 reference point may be used to convey the VUE policy and parameters (including VUE service authorization) from the CN (e.g., AMF) to the UE 102, and convey the VUE 108 and UCM interaction capabilities to the CN CPF (e.g., AMF). Furthermore, establishment of a sync channel and an initial authentication procedure between the VUE 108 and the UE 102 may be done via the N1 reference point. The sync channel establishment and authentication may be done by the AMF following a request from a session mobility function (SMF).

N2 reference point defines a link between a RAN and the CN (e.g., the AMF). In addition to the relevant functions defined in 3GPP TS 23.501, the N2 reference point, configured to support VUE and UCM services, may convey VUE policies and parameters (including a VUE service authorization) from the AMF to the RAN (or a next-generation radio access network (NG-RAN)).

Uu reference point between the UE 102 and the RAN, is configured to support UCM functionality and may provide additional quality of service (QoS) bearers for specific UCM services and sync channels.

### 6.6. Trusted Execution Environment (TEE) of Processor for Hosting D-Users

A TEE is a secure area of a main processor which provides code and data integrity for the applications running inside the TEE. Examples of processors which provide such capabilities include the Intel SGX™ or AMD SEV™ processors. In the TEE, applications can securely store and process data which cannot even be detected by the operating system of a processing device or UE. For example, some systems, such as Intel SGX, may work by creating a secure area of memory, called an enclave, where an application can run. This enclave may be protected by a set of cryptographic keys that are unique to the application and the system it is running on. An enclave may also be considered as a virtual machine (VM) as it may be operated on a separate CPU located in the protected part of the operating system of the hosting network. When an application is executed thereon, the application is sealed inside the enclave, where it can run securely without fear of interference from other processes or from the operating system.

Additionally, TEEs may include a feature called “remote attestation”, which allows a remote party to verify the integrity and security of an enclave, thus providing a way to trust the enclave. Remote attestation may work by allowing a remote party to send a request to the enclave, asking the enclave to provide proof of its identity and integrity. Integrity may refer to the quality of data, functions and/or applications being accurate, consistent, and unaltered. The enclave may then respond by providing a cryptographic signature that may be based on the enclave's unique identity and a set of measurements of the enclave's code and data. The remote party may then verify the signature using a public key provided by the enclave. If the signature is valid, the enclave is authentic and has not been tampered with, allowing the remote party to trust the enclave and its data. The container may thus be protected by a cryptographic key, isolating the container from the Operating System (OS) managing the TEE, the cryptographic key being required to access the DE hosted in the HOP in the container. In possible embodiments, the container may receive an attestation request by a remote device and provide the cryptographic key to the remote device based on a unique identifier of the content or the functionality of the container, to attest authenticity of the container. A remote device may be any processing device that this outside the HOP or the hosting network, and that may need to access contents of a Digital Entity hosted in the HOP. For example, a remote device can be a User Equipment that may need to access an application executed by the digital representative of the user, i.e. the D-User.

In possible embodiments, the proposed method and system may provide for the creation and maintenance of Digital Entities, such as D-Users or D-Reps, inside a TEE, such that even the hosting network may not be able to access the Digital Entity data, including user data or codes (i.e. applications) used by the Digital Entity. In possible embodiments, the entire platform hosting the digital entities, the HOP, may be instantiated in a TEE, such that the HOP and the Digital Entities managed in the platform are isolated by their hosting network. A TEE may correspond to a Confidential Computing Environment (CCE) located inside the HN. In possible embodiments, a user or a customer using the HOP functions or the Digital Entity functions (such as D-User or D-Rep functions) may need to verify that the program codes (software) inside the HOP and the program codes (software) representing each Digital Entity consists of standard or expected codes which do not allow either the HN functions or any external entity to access or tamper with these codes. For this purpose, a remote attestation of the program codes, software or applications executed in the HOP may be provided.

According to possible embodiments, since the HN may be installing the HOP and the initial functions required to create the Digital Entities, such as D-Reps, users requesting the creation of the Digital Entities and/interacting with the Digital Entities may require a guarantee that the Digital Entities, the HOP or the hosting network cannot present a breach in privacy.

Therefore, a method may be provided for allowing users and/or customers to verify the program codes and applications used by the Hosting Network and/or HOP, according to a standard process. According to a possible embodiment, users may be provided with means to upload the program codes of the functions to the Digital Entity and/or instantiate those functions inside the Digital Entity. However, users may not be able to develop such program codes on their own and may need to obtain the program codes from a vendor. In order for the user to verify the legitimacy and credentials of a given functionality, program codes may be standardized and standard testing methods may be provided. Test methods may be standardized as well. Independent organizations testing the program codes may have the authority to certify program codes as certified or approved. Users may thus have access to certified program codes when they need the program codes to be executed in the Digital World provided by the Hosting Network.

In other embodiments, the certification may be done by the user or customer directly, using a testing program, which can perform remote attestation of program codes running in the HOP and/or Digital Entities. A program code or software to be executed by a Digital Entity may be provided with a cryptographic signature, such as a hash of the program code. The user may be able, via a testing program or software, to verify the hash of the program code.

A possible issue may be that, even if a user has installed a certified version of an application or of a function inside a Digital Entity (such as a D-Rep or a D-User), the application or function already created inside the Digital Entity by the HOP or by the Hosting Network may not be credible or certified. In this case, functions such as the Digital Entity Manager (D-Rep-M) and HOP functions (HPFs) may need to be tested for credibility/authenticity.

According to a possible embodiment, certified TEE vendors may be trusted to use certified program codes for the instantiation or creation of the HOP and Digital Entities hosted therein. According to another embodiment, a TEE vendor may be required to install only certified versions of those program codes so that when a user undergoes remote attestation of the program code inside the container, the signature of the container and/or program codes may be obtained and verified by a trusted authority, such as an approved 3rd party organization certified to validate the certified signatures. The User Equipment (UE) may verify authenticity of the container by providing a cryptographic key to a 3rd party device. In return, the 3rd party device can provide at least one of: the container; contents inside the container; and functionalities of the container to confirm the authenticity of the container. A 3rd party can act as an authentication entity, which may verify the authenticity of the contents of the HOP. A 3rd party device can be a server controlled and managed by the authentication entity.

Consequently, two types of standardized functions may be required, a first certified function for the HOP, and a second certified version for the Digital Entities, such as D-Reps, which may be verifiable using standard tests.

In possible embodiments, and in the context of the present application, a TEE can be preconfigured or preinstalled with specific program codes which may enable the TEE to perform some of the following functions:
Automatically create (or self-create) certified versions of Digital Entities inside the TEE according to blueprints provided beforehand when requested to create a Digital Entity by a Hosting Network Function (HNF). The creation of the Digital Entities may include providing a secure key and a physical entity address (such as a MAC or IP address) to establish secure communications between the Digital Entities (such as D-Reps) and the physical entity. A “certified version” of a Digital Entity may be a Digital Entity blueprint, corresponding to a standard description kept inside the TEE. The blueprint may correspond to an approved version certified by a standard organization;
Provide functions inside the HOP, such as HOP management functions (HMF), to control access from outside HOP to internal functions of the HOP;
Allow a limited number of operations to be performed when requested by an HNF. These limited number of operations can comprise the creation or deletion of Digital Entities, resource assignment for the Digital Entities, establishment of links with physical entities.

Once a secure communication link is established between a Digital Entity and the physical entity, the physical entity may be able to attest the HOP and Digital Entity program codes as credible or certified ones, that is, untampered or unaltered by the HN or by any other entity. In order to ensure integrity of the HOP, the physical entity may obtain a state of the current program code of the HOP, and may verify the HOP program code with the TEE provider to ensure the authenticity and/or credibility of the HOP program code. A remote attestation service may be provided by the TEEs, comprising for example a hash of the code used by the HOP and the D-Rep).

After remote attestation, the physical entity may request the network services needed and the HOP can facilitate providing the network service requirements when requested by the Digital Entities.

When the HN is not a trusted network with regard to the physical entity, the use of a TEE to create the HOP and the Digital Entities hosted therein may allow for the provision of a secure area inside the Hosting Network. The Hosting Network (HN), or network provider, may be able to guarantee the user and related physical devices that the area is closed and inaccessible to the network provider. When the HN receives a TEE by a TEE provider, the TEE may be provided with an access key, such as a cryptographic key, to access the TEE. The access key can be handed over to the end user (or UE) while providing an anchor function through which messages to and from the Digital Entity can be sent. Data and applications inside the TEE should not be tampered with by the HN. This preservation of privacy can be achieved by only allowing specific operations to be carried out by the HN, such as controlling code and functions already inserted inside the TEE by the TEE provider, which cannot be tampered with.

### 6.7. NET4DW Service Module

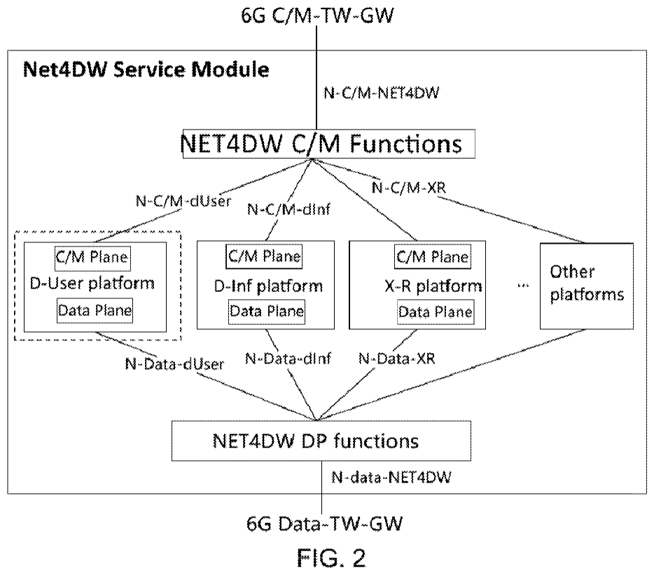

Referring to FIG. 2, in possible embodiments, a digital world network service module is schematically illustrated, which can provide Digital World (DW) services and which may include a capability to construct, control and manage objects and entities in a digital or virtual world. The digital world network service module may also be referred to herein as a “NET4DW” service module. A digital world can be defined as a digital realization or implementation of a physical world, including for example people, processes, animals, objects, such as robots, cars, lights, and infrastructures, such as roads, organizations, buildings and factories. For this application, the terms digital entities, DE, D-XX, DE module or D-XX module may be used to represent any of the above items. The NET4DW service module may provide different services to allow applications to run or be executed in the DW. In particular, the NET4DW service module may include D-Users, which correspond to digital representations of physical users (P-Users). Currently, some form of digital representation of a user is available in certain metaverses or servers such as Facebook™, Amazon™, Google™, etc. The required representation can vary from application to application and can vary from using user data to controlling personal items and actions on behalf of the user.

A D-User can comprise a set of parameters and data corresponding to characteristics of a real, physical person or animal, including not only nominative data, such as a name, age, address, but also other characteristics, such as real-time location, heartbeat, medical conditions, preferences, physiological data, the user context, environmental context, mobility, past activities which can be gathered from sensors or not. A D-User may also comprise one or more software applications or modules that can simulate, predict or replicate the behavior or condition of the real, physical person associated with the D-User. Operational data defines operations performed by functions of the one or more D-Reps or D-Users. Operational data may comprise one or more of: processing of input data, modifying input data, forwarding input data or processed data to a specified destination, deleting input data, creation of other functions and life cycle management of other functions, resource assignment for other functions, modifying other functions.

FIG. 2 provides an exemplary high-level architecture of an NET4DW service module.

As shown in FIG. 2, NET4DW may include different types of Hosting Platform (HOP) for hosting Digital Entities, such as D-User platforms, D-Inf platforms and any other DW platforms such as Virtual Reality (X-R) platforms. These platforms may host one or more digital entities, which are commonly termed DE, DE module, D-XX or D-XX modules in the present disclosure. A D-Inf platform may contain digital representatives (D-Reps or D-Rep modules) of different physical objects, such buildings, roads or lights, and D-Inf can replicate an infrastructure such as a city, as an example only.

In the diagram C/M refers to control and management plane and DP refers to data plane. Net4DW C/M functions are the control and management functions of the NET4DW to manage and coordinate the platform interactions required for different DW applications. It may also include the Control and Management Gateway (C/M G/W) function though which the NET4DW C/M functions interact with the external C/M functions. Similarly, DP functions are the data plane functions such as routing and data processing functions. Each platform has its own C/M and DP functions and they may connect to Net4DW functions through G/W functions. A HOP platform may be a single Digital Entity platform or a multiple Digital Entity Platform (multiple DE-HOP). For example, a single D-User HOP may be used for hosting a single D-User (replica of a physical user) or multiple D-User platform may be used for hosting multiple D-Users, for example, a group of friends or a family.

Details of NET4DW functions, which may need to be instantiated when the NET4DW platform is created, may be needed for its proper creation and operation.

In addition, the digital entities (D-XX) used in the NET4DW and the NET4DW operations may require privacy preservation. In particular, the DW operations may need to be isolated from the hosting networks. Therefore, the hosting platforms discussed in this application may be used for providing in-network DWs as well.

One technical problem that is addressed in this application is the creation an isolated hosting platform (HOP) for digital entities (D-XX) inside the hosting network which may instantiate the entities when needed. The functions in the hosting network to create the hosting platform (referred to as Hosting Network Function-HNFs) and the functions inside the hosting platform (referred to as HOP Network Functions-HPFs) which may enable the creation digital entities (D-XX), including D-Users, are also included.

This application also provides different options that the network operator may use to create the hosting platforms (HOPs). Platforms can take various forms, such as a single-entity platform like a D-User platform, or a multi-entity platform like a multi-D-User platform, a NET4DW platform, or an isolated function module within the hosting network. Creation procedures are outlined separately for each case, along with descriptions of the functional architecture of the platform, including its main functions and interfaces.

The hosting network (NH) can be a trusted network or an untrusted network. In the untrusted case, this application may further provide methods to prevent the hosting network from accessing the digital entity data when a user requires processing to process data inside the HOP or when a user shares data with external devices outside the hosting network, such as 3rd parties.

In addition, in the untrusted case, this application may provide methods to create the hosting platform (HOP) to prevent the hosting network (HN) from accessing information about the external servers the digital entities (such as D-User) access.

In addition, in the untrusted case, this application describes how the HOP may be created to anonymously access external servers (or 3rd party servers) and also prevent the hosting network to access this information.

### 6.8. Communication Network System

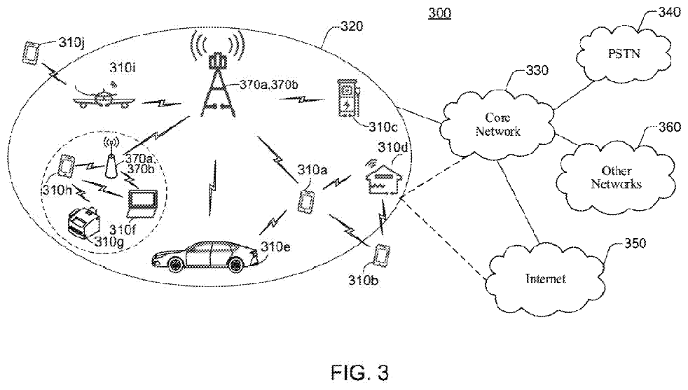

Referring to FIG. 3, as an illustrative example without limitation, a simplified schematic illustration of a communication network system is provided. The communication system 300 comprises a radio access network (RAN) 320. The radio access network 320 may be a next generation (e.g. sixth generation (6G) or later) radio access network, or a legacy (e.g. 5G, 4G, 3G or 2G) radio access network. One or more communication electronic devices (ED), including for example User Equipment (UE), 310a, 310b, 310c, 310d, 310e, 310f, 310g, 310h, 310i, 310j (generically referred to as 310) may be interconnected to one another or connected to one or more network nodes (370a, 370b, generically referred to as 370) in the radio access network 320. A core network 330 may be a part of the communication system and may be dependent or independent of the radio access technology used in the communication system 300. Also, the communication system 300 comprises a public switched telephone network (PSTN) 340, the internet 350, and other networks 360.

### 6.9. Communication System with Wired and Wireless Elements

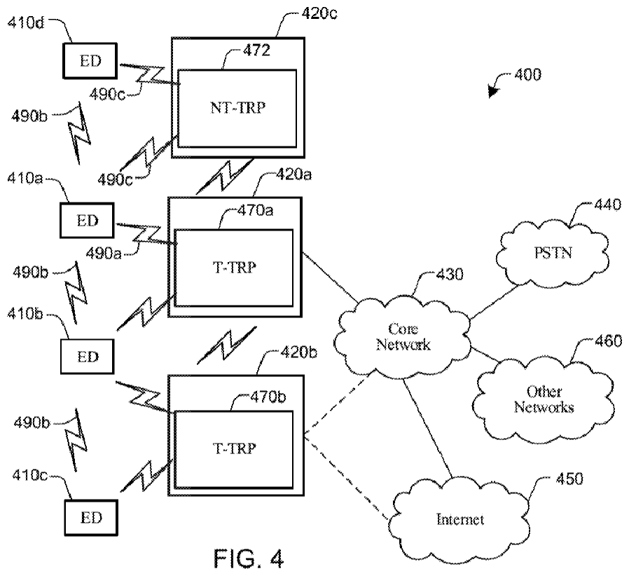

FIG. 4 illustrates an example communication system 400. In general, the communication system 400 enables multiple wireless or wired elements to communicate data and other content. The purpose of the communication system 400 may be to provide content, such as voice, data, video, and/or text, via broadcast, multicast, groupcast, unicast, etc. The communication system 400 may operate by sharing resources, such as carrier spectrum bandwidth, between its constituent elements. The communication system 400 may include a terrestrial communication system and/or a non-terrestrial communication system. The communication system 400 may provide a wide range of communication services and applications (such as earth monitoring, remote sensing, passive sensing and positioning, navigation and tracking, autonomous delivery and mobility, etc.). The communication system 400 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered subsystems of the communication system. In the example shown in FIG. 4, the communication system 400 includes electronic devices (ED) 410a, 410b, 410c, 410d (generically referred to as ED 410, which may include User Equipment (UE)), radio access networks (RANs) 420a, 420b, a non-terrestrial communication network 420c, a core network 430, a public switched telephone network (PSTN) 440, the Internet 450, and other networks 460. The RANs 420a, 420b include respective base stations (BSs) 470a, 470b, which may be generically referred to as terrestrial transmit and receive points (T-TRPs) 470a, 470b. The non-terrestrial communication network 420c includes an access node 472, which may be generically referred to as a non-terrestrial transmit and receive point (NT-TRP) 472.

Any ED 410 may be alternatively or additionally configured to interface, access, or communicate with any T-TRP 470a,470b and NT-TRP 472, the Internet 450, the core network 430, the PSTN 440, the other networks 460, or any combination of the preceding. In some examples, ED 410a may communicate an uplink and/or downlink transmission over a terrestrial air interface 490a with T-TRP 470a. In some examples, the EDs 410a, 410b, 410c, and 410d may also communicate directly with one another via one or more sidelink air interfaces 190b. In some examples, ED 410d may communicate an uplink and/or downlink transmission over a non-terrestrial air interface 190c with NT-TRP 472.

The air interfaces 490a and 490b may use similar communication technology, such as any suitable radio access technology. For example, the communication system 400 may implement one or more channel access methods, such as code division multiple access (CDMA), space division multiple access (SDMA), time division multiple access (TDMA), frequency division multiple access (FDMA), orthogonal FDMA (OFDMA), or single-carrier FDMA (SC-FDMA, also known as discrete Fourier transform spread OFDMA, DFT-s-OFDMA) in the air interfaces 490a and 490b. The air interfaces 490a and 490b may utilize other higher dimension signal spaces, which may involve a combination of orthogonal and/or non-orthogonal dimensions.

The non-terrestrial air interface 490c can enable communication between the ED 410d and one or multiple NT-TRPs 472 via a wireless link or simply a link. For some examples, the link is a dedicated connection for unicast transmission, a connection for broadcast transmission, or a connection between a group of EDs 410 and one or multiple NT-TRPs 472 for multicast transmission.

The RANs 420a and 420b are in communication with the core network 430 to provide the EDs 410a, 410b, and 410c with various services such as voice, data, and other services. The RANs 420a and 420b and/or the core network 430 may be in direct or indirect communication with one or more other RANs (not shown), which may or may not be directly served by core network 430, and may or may not employ the same radio access technology as RAN 120a, RAN 420b or both. The core network 430 may also serve as a gateway access between (i) the RANs 420a and 420b or EDs 410a 110b, and 410c or both, and (ii) other networks (such as the PSTN 440, the Internet 450, and the other networks 460). In addition, some or all of the EDs 410a, 410b, and 410c may include functionality for communicating with different wireless networks over different wireless links using different wireless technologies and/or protocols. Instead of wireless communication (or in addition thereto), the EDs 410a, 410b, and 410c may communicate via wired communication channels to a service provider or switch (not shown), and to the Internet 450. PSTN 440 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 410a, 410b, and 410c may be multimode devices capable of operation according to multiple radio access technologies, and incorporate multiple transceivers necessary to support such.

### 6.10. Electronic Device (ED) and T-TRP/NT-TRP

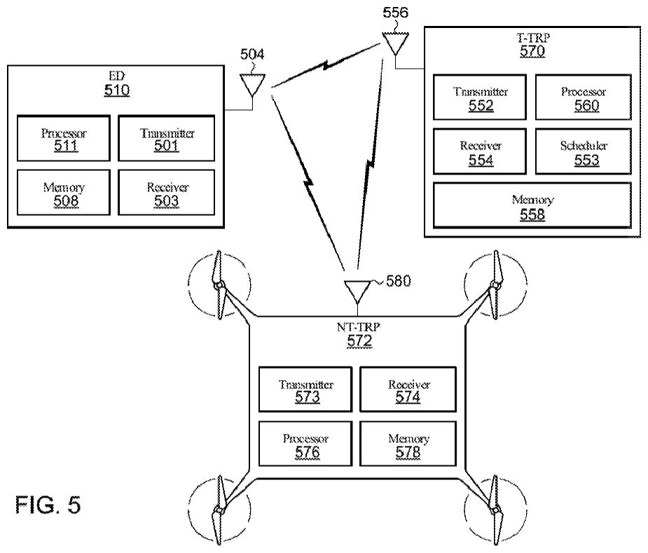

FIG. 5 illustrates another example of an ED 510 and a base station 570a, 570b 5 and/or 570c. The ED 510 is used to connect persons, objects, machines, etc. The ED 510 may be widely used in various scenarios including, for example, cellular communications, device-to-device (D2D), vehicle to everything (V2X), peer-to-peer (P2P), machine-to-machine (M2M), machine-type communications (MTC), internet of things (IoT), virtual reality (VR), augmented reality (AR), mixed reality (MR), metaverse, digital twin, industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 510 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, wearable devices (such as a watch, a pair of glasses, head mounted equipment, etc.), an industrial device, or an apparatus in (e.g. communication module, modem, or chip) or comprising the forgoing devices, among other possibilities. Future generation EDs 510 may be referred to using other terms. The base station 570a and 570b is a T-TRP and will hereafter be referred to as T-TRP 570. Also shown FIG. 5, a NT-TRP will hereafter be referred to as NT-TRP 572. Each ED 110 connected to T-TRP 570 and/or NT-TRP 572 can be dynamically or semi-statically turned-on (i.e., established, activated, or enabled), turned-off (i.e., released, deactivated, or disabled) and/or configured in response to one of more of: connection availability and connection necessity.

The ED 510 includes a transmitter 501 and a receiver 503 coupled to one or more antennas 504. Only one antenna 504 is illustrated to avoid congestion in the drawing. One, some, or all of the antennas 504 may alternatively be panels. The transmitter 501 and the receiver 503 may be integrated, e.g. as a transceiver. The transceiver is configured to modulate data or other content for transmission by at least one antenna 504 or network interface controller (NIC). The transceiver is also configured to demodulate data or other content received by the at least one antenna 504. Each transceiver includes any suitable structure for generating signals for wireless or wired transmission and/or processing signals received wirelessly or by wire. Each antenna 504 includes any suitable structure for transmitting and/or receiving wireless or wired signals.

The ED 510 includes at least one memory 508. The memory 508 stores instructions and data used, generated, or collected by the ED 110. For example, the memory 508 could store software instructions or modules configured to implement some or all of the functionality and/or embodiments described herein and that are executed by one or more processing unit(s) (e.g., a processor 510). Each memory 508 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 510 may further include one or more input/output devices (not shown) or interfaces (such as a wired interface to the Internet 350 in FIG. 3). The input/output devices or interfaces permit interaction with a user or other devices in the network. Each input/output device or interface includes any suitable structure for providing information to or receiving information from a user, and/or for network interface communications. Suitable structures include, for example, a speaker, microphone, keypad, keyboard, display, touch screen, etc.

The ED 510 includes the processor 511 for performing operations including those operations related to preparing a transmission for uplink transmission to the NT-TRP 572 and/or the T-TRP 570; those operations related to processing downlink transmissions received from the NT-TRP 572 and/or the T-TRP 570; and those operations related to processing sidelink transmission to and from another ED 510. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 503, possibly using receive beamforming, and the processor 511 may extract signaling from the downlink transmission (e.g. by detecting and/or decoding the signaling). An example of signaling may be a reference signal transmitted by the NT-TRP 572 and/or by the T-TRP 570. In some embodiments, the processor 511 implements the transmit beamforming and/or the receive beamforming based on the indication of beam direction, e.g. beam angle information (BAI), received from the T-TRP 570. In some embodiments, the processor 511 may perform operations relating to network access (e.g. initial access) and/or downlink synchronization, such as operations relating to detecting a synchronization sequence, decoding and obtaining the system information, etc. In some embodiments, the processor 511 may perform channel estimation, e.g. using a reference signal received from the NT-TRP 570 and/or from the T-TRP 570.

Although not illustrated, the processor 511 may form part of the transmitter 501 and/or part of the receiver 503. Although not illustrated, the memory 508 may form part of the processor 511.

The processor 511, the processing components of the transmitter 501, and the processing components of the receiver 503 may each be implemented by the same or different one or more processors that are configured to execute instructions stored in a memory (e.g. in the memory 508). Alternatively, some or all of the processor 511, the processing components of the transmitter 501, and the processing components of the receiver 203 may each be implemented using dedicated circuitry, such as a programmed field-programmable gate array (FPGA), an application-specific integrated circuit (ASIC), or a hardware accelerator such as a graphics processing unit (GPU) or an artificial intelligence (AI) accelerator.

The T-TRP 570 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a terrestrial node, a terrestrial network device, a terrestrial base station, a base band unit (BBU), a remote radio unit (RRU), an active antenna unit (AAU), a remote radio head (RRH), a central unit (CU), a distributed unit (DU), a positioning node, among other possibilities. The T-TRP 170 may be a macro BS, a pico BS, a relay node, a donor node, or the like, or combinations thereof. The T-TRP 570 may refer to the forgoing devices or refer to apparatus (e.g. a communication module, a modem, or a chip) in the forgoing devices.

In some embodiments, the parts of the T-TRP 570 may be distributed. For example, some of the modules of the T-TRP 570 may be located remote from the equipment that houses the antennas 256 for the T-TRP 570, and may be coupled to the equipment that houses the antennas 556 over a communication link (not shown) sometimes known as front haul, such as common public radio interface (CPRI). Therefore, in some embodiments, the term T-TRP 570 may also refer to modules on the network side that perform processing operations, such as determining the location of the ED 510, resource allocation (scheduling), message generation, and encoding/decoding, and that are not necessarily part of the equipment that houses the antennas 556 of the T-TRP 570. The modules may also be coupled to other T-TRPs. In some embodiments, the T-TRP 570 may actually be a plurality of T-TRPs that are operating together to serve the ED 510, e.g. through the use of coordinated multipoint transmissions.

The T-TRP 570 includes at least one transmitter 552 and at least one receiver 554 coupled to one or more antennas 556. Only one antenna 256 is illustrated to avoid congestion in the drawing. One, some, or all of the antennas 256 may alternatively be panels. The transmitter 552 and the receiver 554 may be integrated as a transceiver. The T-TRP 570 further includes a processor 560 for performing operations including those related to: preparing a transmission for downlink transmission to the ED 510, processing an uplink transmission received from the ED 510, preparing a transmission for backhaul transmission to the NT-TRP 572, and processing a transmission received over backhaul from the NT-TRP 572. Processing operations related to preparing a transmission for downlink or backhaul transmission may include operations such as encoding, modulating, precoding (e.g. multiple input multiple output (MIMO) precoding), transmit beamforming, and generating symbols for transmission. Processing operations related to processing received transmissions in the uplink or over backhaul may include operations such as receive beamforming, demodulating received symbols, and decoding received symbols. The processor 511 may also perform operations relating to network access (e.g. initial access) and/or downlink synchronization, such as generating the content of synchronization signal blocks (SSBs), generating the system information, etc. In some embodiments, the processor 560 also generates an indication of beam direction, e.g. BAI, which may be scheduled for transmission by a scheduler 553. The processor 260 performs other network-side processing operations described herein, such as determining the location of the ED 510, determining where to deploy the NT-TRP 572, etc. In some embodiments, the processor 560 may generate signaling, e.g. to configure one or more parameters of the ED 510 and/or one or more parameters of the NT-TRP 572. Any signaling generated by the processor 560 is sent by the transmitter 552. Note that “signaling”, as used herein, may alternatively be called control signaling. Signaling may be transmitted in a physical layer control channel, e.g. a physical downlink control channel (PDCCH), in which case the signaling may be known as dynamic signaling. Signaling transmitted in a downlink physical layer control channel may be known as Downlink Control Information (DCI). Signaling transmitted in an uplink physical layer control channel may be known as Uplink Control Information (UCI). Signaling transmitted in a sidelink physical layer control channel may be known as Sidelink Control Information (SCI). Signaling may be included in a higher-layer (e.g., higher than physical layer) packet transmitted in a physical layer data channel, e.g. in a physical downlink shared channel (PDSCH), in which case the signaling may be known as higher-layer signaling, static signaling, or semi-static signaling. Higher-layer signaling may also refer to Radio Resource Control (RRC) protocol signaling or Media Access Control-Control Element (MAC-CE) signaling.

The scheduler 553 may be coupled to the processor 560. The scheduler 553 may be included within or operated separately from the T-TRP 170. The scheduler 553 may schedule uplink, downlink, sidelink, and/or backhaul transmissions, including issuing scheduling grants and/or configuring scheduling-free (e.g., “configured grant”) resources. The T-TRP 170 further includes a memory 558 for storing information and data. The memory 258 stores instructions and data used, generated, or collected by the T-TRP 170. For example, the memory 558 could store software instructions or modules configured to implement some or all of the functionality and/or embodiments described herein and that are executed by the processor 560.

Although not illustrated, the processor 560 may form part of the transmitter 552 and/or part of the receiver 554. Also, although not illustrated, the processor 560 may implement the scheduler 553. Although not illustrated, the memory 558 may form part of the processor 560.

The processor 560, the scheduler 553, the processing components of the transmitter 252, and the processing components of the receiver 554 may each be implemented by the same or different one or more processors that are configured to execute instructions stored in a memory, e.g. in the memory 558. Alternatively, some or all of the processor 560, the scheduler 553, the processing components of the transmitter 552, and the processing components of the receiver 554 may be implemented using dedicated circuitry, such as a programmed FPGA, a hardware accelerator (e.g., a GPU or AI accelerator), or an ASIC.

Although the NT-TRP 572 is illustrated as a drone only as an example, the NT-TRP 572 may be implemented in any suitable non-terrestrial form, such as satellites and high altitude platforms, including international mobile telecommunication base stations and unmanned aerial vehicles, for example. Also, the NT-TRP 572 may be known by other names in some implementations, such as a non-terrestrial node, a non-terrestrial network device, or a non-terrestrial base station. The NT-TRP 572 includes a transmitter 572 and a receiver 574 coupled to one or more antennas 580. Only one antenna 580 is illustrated to avoid congestion in the drawing. One, some, or all of the antennas may alternatively be panels. The transmitter 572 and the receiver 574 may be integrated as a transceiver. The NT-TRP 572 further includes a processor 576 for performing operations including those related to: preparing a transmission for downlink transmission to the ED 510, processing an uplink transmission received from the ED 510, preparing a transmission for backhaul transmission to T-TRP 570, and processing a transmission received over backhaul from the T-TRP 570. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, demodulating received symbols, and decoding received symbols. In some embodiments, the processor 276 implements the transmit beamforming and/or receive beamforming based on beam direction information (e.g. BAI) received from the T-TRP 570. In some embodiments, the processor 576 may generate signaling, e.g. to configure one or more parameters of the ED 510. In some embodiments, the NT-TRP 572 implements physical layer processing, but does not implement higher layer functions such as functions at the medium access control (MAC) or radio link control (RLC) layer. As this is only an example, more generally, the NT-TRP 572 may implement higher layer functions in addition to physical layer processing.

The NT-TRP 572 further includes a memory 578 for storing information and data. Although not illustrated, the processor 576 may form part of the transmitter 572 and/or part of the receiver 574. Although not illustrated, the memory 578 may form part of the processor 576.

The processor 576, the processing components of the transmitter 572, and the processing components of the receiver 574 may each be implemented by the same or different one or more processors that are configured to execute instructions stored in a memory, e.g. in the memory 578. Alternatively, some or all of the processor 576, the processing components of the transmitter 572, and the processing components of the receiver 574 may be implemented using dedicated circuitry, such as a programmed FPGA, a hardware accelerator (e.g., a GPU or AI accelerator), or an ASIC. In some embodiments, the NT-TRP 572 may actually be a plurality of NT-TRPs that are operating together to serve the ED 510, e.g. through coordinated multipoint transmissions.

The T-TRP 570, the NT-TRP 572, and/or the ED 510 may include other components, but these have been omitted for the sake of clarity.

### 6.11. Electronic Device Modules

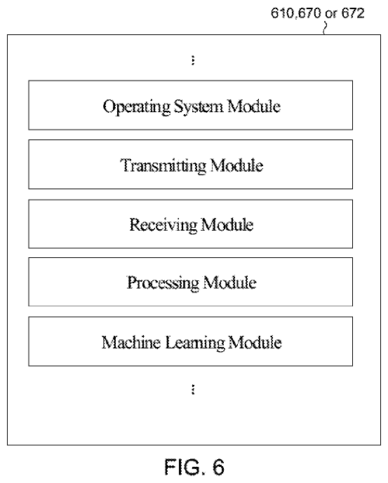

One or more steps of the embodiment methods provided herein may be performed by corresponding units or modules, according to FIG. 6. FIG. 6 illustrates units or modules in a device, such as in the ED 610, in the T-TRP 670, or in the NT-TRP 672. For example, a signal may be transmitted by a transmitting unit or by a transmitting module. A signal may be received by a receiving unit or by a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be a circuit such as an integrated circuit. Examples of an integrated circuit includes a programmed FPGA, a GPU, or an ASIC. For instance, one or more of the units or modules may be logical such as a logical function performed by a circuit, by a portion of an integrated circuit, or by software instructions executed by a processor. It may be appreciated that where the modules are implemented using software for execution by a processor for example, the modules may be retrieved by a processor, in whole or part as needed, individually or together for processing, in single or multiple instances, and that the modules themselves may include instructions for further deployment and instantiation.

Additional details regarding the EDs 610, the T-TRP 670, and the NT-TRP 672 are known to those of skill in the art. As such, these details are omitted here.

The solution described in the application is applicable to a next generation (e.g. sixth generation (6G) or later) network, or a legacy (e.g. 5G, 4G, 3G or 2G) network.

In possible embodiments, the proposed System architecture is defined to support XaaS services by using techniques such as Network Function Virtualization and Network Slicing. The System architecture utilizes service-based interactions between services.

### 6.12. Service-Based Architecture

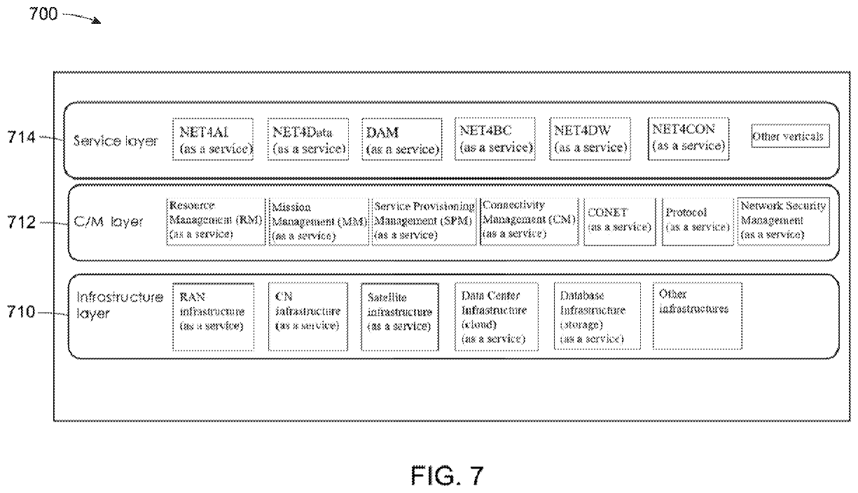

In possible embodiments, the network system 700, which can be a network system (such as a 6G network system), leverages service-based architecture and XaaS concept. XaaS services in the system are categorized into three layers 710, 712, 714. A possible embodiment of a system conceptual structure is shown in FIG. 7.

In possible embodiments, Infrastructure Layer 710 may include infrastructures supporting, for example, 6G services. Among them are wireless networks (RAN, CN) infrastructures, Cloud/data center infrastructures, satellite networks, storage/database infrastructures, and sensing networks, and etc. These infrastructures can be provided by a single provider or by multiple providers.

Each of the infrastructures may have its control and management functions, denoted as C/M functions, for infrastructure management. Each of these infrastructures can be one type of Infrastructure as a Service.

In possible embodiments, Control and Management (C/M) layer 712 may include control and management services of the System. They are developed and deployed by using slicing techniques and utilizing resource provided by infrastructure layer. services in Control and Management (C/M) layer 712 may include:
A Resource Management module comprising Resource Management (RM) as a Service functions, which may provide a capability of life-cycle management of a variety of slices and over-the-air resource assignment to wireless devices;
A mission module defined as a service provided to customers by the System. A mission can be a set of services which is provided by a single XaaS service or a type of services that needs contributions from multiple XaaS services;
A Mission Management module comprising Mission Management (MM) as a Service functions, which may provide a capability to program provisioning of XaaS services at Service Layer to provide mission services;
A CONET module comprising Confederation Network (CONET) as a Service functions, which may provide a capability to enable multiple partners to jointly provide services. This capability is provided by confederation formation, mutual authentication, mutual authorization among partners and negotiation of agreement on recording and retracing of selected actions performed by partners, in order to assure a trustworthy environment of System operations
A Service Provisioning Management module functions, which comprises Service Provisioning Management (SPM) as a Service, to provide a capability of control and management of service access by customers and provisioning of requested services. The capability is provided by unified mutual authentication, authorization and policy, key management, QoS assurance and charging between any pair of XaaS service provider and customer. The customers include end-customers not only in physical world, but also digital representatives in digital world;
A Connectivity Management module, which comprises Connectivity Management (CM) as a Service functions, to leverage connectivity management functions of current or previous systems such as 5G, but with extension to include digital world;
A Protocol as a Service module, which comprises Protocol as a Service functions to provide a capability to design service customized protocol stacks for identified interfaces. The protocol stacks can be predefined for on-demand selection, or can be on-demand designed;
A Network Security as a Service module, which comprises Network Security as a Service functions to provide a capability for owners of infrastructures to detect potential security risks of their infrastructures;
A XaaS module, comprising XaaS services in the C/M Layer support control and management 712 of the System itself and also provide support to verticals if requested. One example is that RM service can serve RAN for over-the-air resource management and can also provide service to a vertical for the vertical's over-the-air resource allocation to its end-customers. The XaaS in C/M layer can be deployed by using slicing technique.

Service Layer 714 may include services which provide services to customers. In the System structure 700, the following modules may be included:
An AI service module, denoted as NET4AI as a Service. Artificial Intelligence service functions provide AI capability to support a variety of AI applications;
A Analytics Module (DAM) comprising Service of data collection, data sanitization, data analysis and data delivery functions, denoted as DAM as a Service, this service provides a capability of lifecycle management of statistic data, including acquisition, de-privatization, analysis and delivery of data which are information statistic data from any types of sensors, devices, network functions etc.;
A NET4Data module, comprising Service of storage and sharing of data, denoted as NET4Data as a Service. This service module provides a capability to trustworthy storage and share data under the control of owners of data and following recognized authorities' regulations on control of identified data;
A NET4DW module, comprising Service to provide digital world, denoted as NET4DW as a Service. The Digital World module (or system) provide a capability to construct, control and manage digital world. Digital world is defined as digital realization of physical world;
A block chain module, comprising block chain service is denoted as NET4BC as a Service. A connectivity service is denoted as NET4Con as a Service. This service provides a capability to support block chain services;
A NET4CON module, comprising Enhanced connectivity service, e.g., network for connectivity (NET4CON) as a service. This service provides a capability to support exchange of messages and data among new services.

All XaaS services at this Layer may developed and deployed by using resources provided in the infrastructure and utilizing Network Function Virtualization and Slicing techniques. The capability of each of the services is provided by its control and management (C/M) functions and service specific data process functions.

In addition to support XaaS services at Service Layer 714, the System 700 leverages existing systems, such as 5G Systems, for provisioning of vertical services. The difference between XaaS services and other verticals are that a vertical is a pure customer which needs other XaaS services to enable its operation, while each of XaaS services provide their capabilities to customers.

Any pair of XaaS services of the System may also be mutual customer and provider of each other. Some examples are that an infrastructure owner providing its resource to XaaS services in the Service Layer 714 and C/M Layer 712; RM services may need the capabilities provided by NET4AI, DAM and NET4DW for its resource management for vertical slicing; CONET service and NET4Data service may need the capability provided by NET4BC for their operation.

The structure and associated modules/platform of the proposed System may provide the following functionalities and advantages:

Define Basic XaaS Services by decoupling comprehensive types of services into basic XaaS services. A basic XaaS service provides unique capability to enable a specific type of service, such as NET4AI service, NET4DW service, DAM service, NET4Data service, Block chain service, mission management service, etc.
Allow joint operation of the System by multiple partners;
Define Data Plane of the System which includes processing functions of data plane of XaaS services. Programing the interconnection of these functions, by mission management service, enables to support a variety of customized customer services;
Simplify System architecture by categorizing basic control services and management services and combining them as basic XaaS services in Control and Management (C/M) Layer;
Define C/M Plane of the System which includes C/M functions in XaaS services and may include 5G CP (e.g., AMF) depending on implementation options;
Define Basic Architecture Structure (BAS) which is a unified basic structure with minimized number of interfaces and is independent of types of infrastructures.

Simplify standardization, development and deployment of the System using the BAS concept, while supporting a variety of infrastructure deployment scenarios;
Adapt to a variety of deployment scenarios by applying the BAS or a subset of it to infrastructures based on capability, capacity and requirement of the infrastructure networks;
Leverage SBI interface concept and apply SBI interaction in both C/M plane and data plane;
Simplify SBI interfaces by introducing trustworthy GWs in Data Plane and C/M Plane of the System;
Improve trustworthiness from perspectives of operation of the System by introducing CONET capability, NET4BC capability and anonymous service provisioning provided by the trustworthy GWs in the C/M plane and data plane of the System;
Improve trustworthiness from perspective of end customer privacy protection by unified mutual authentication, IDM, data sanitization and etc. provided by SPM service, DAM service and Block Chain service;
Simplify roaming management of wireless devices, in the physical world and digital world, by unified authentication including all participated partners and customers.
Support multiple development paths from current systems to future systems by defining multiple architecture options without incurring much efforts due to the introduction of the BAS concept;
Support backward compatibility by utilizing benefits of SBA and its add-on feature. Users older technologies (e.g. 5G) can use the new system (e.g. 6G) to access services from the older technology;
Support future extension by adding new XaaS services with minimized impact on standardization and deployment, due to the introduced anonymous service provisioning concept implemented in trustworthy GWs in C/M plane and in data plane.

### 6.13. D-User and User Controlled and Managed (UCM) Services

Since any information provided from a user access device (UAD), or a user application can be regarded as personal data, the term ‘user’ is used to represent one or more of physical user (P-User), user equipment (UE), User access device (UAD) or user applications.

A Physical User (P-User) correspond to a real, physical entity using a network service, and can therefore correspond to a human, an animal or a machine such as a robot.

A user equipment (UE) can correspond to the equipment used by the P-User to interact with the network. The UE may consist of two parts, user personal device (UPD) where all user applications and other information is kept and User Access Device (UAD) which is the device used to access the network. UAD may be a public device which may be used by multiple users. The various sensors connected to the device may be considered as part of UPD as they carry user information. Therefore, UE may also correspond to a user access device (UAD), user applications and sensors.

The term ‘Digital User’ (D-User) refers to a digital representation of a user and may be described as a digital representation of one or more of:
real or physical user (P-User) such as a human, animal, or a robot,
P-User access device (UAD),
User equipment (UE),
UE sensors, and
user application.

The term ‘D-Rep’ refers to a Digital Representation and corresponds to a type of Digital Entity (D-XX). A D-Rep is the digital representation of any real physical objects or set of objects. The D-Reps can correspond to replicas or digital representatives of physical devices, including vehicles such as cars and robots, provided with connectivity to the network and sensors. Other types of digital entities include digital infrastructures (D-Inf) or digital networks (D-Net). A D-User is also another type of digital entity. The D-Users can be digital representatives of real or physical users (P-Users); P-User access device (UAD); User Equipment (UE); UE sensors; physical devices, and user applications.

Any type of Digital Entity (DE/D-XX), such as D-Users or a D-Reps, may be placed, that is, instantiated, stored, maintained and controlled, inside a Hosting Platform (HOP) of any type of network (hosting network) such as a WiFi network, a mobile network (RAN or CN) or any data network (DN), including 6G networks. When a network provides the resources to create and maintain HOPs, the network can be referred to as a Hosting Network (HN).

The following description in this document describes the services provided using a digital user as a special case of the services provided by a digital entity. Therefore, the methods and procedures describes in the document can be applied similarly to any digital entity which can be understood by a person skilled in the art.

For example, similar to user controlled and managed services provided using a D-User, there are digital entity customer controlled and managed services using a digital entity.

In possible embodiments, an in-network D-User (i.e., a D-User hosted in a HOP) may act on behalf of the user and provide D-User services which can be termed as User-Controlled and Managed (UCM) services. For example, these can include: analyzing and processing user data, providing a computing platform to run user applications, providing AI services to the user, home control of the user, financial and health control, handling data sharing with the 3rd parties, processing user data, acting on behalf of the user, obtaining content from 3rd party content providers, interacting with the network to obtain better communication services, interacting with the network to obtain network data, facilitating the interactions with 3rd party servers, such as user accessing application servers and making payment and receiving payments.

Some of these actions are very personal to an entity, such as a user and, therefore, exposure of the D-User data and operations may be limited or prevented from the hosting network. Such protection may not be needed if the hosting network is a trusted network. However, the trustworthiness may depend on the type of the services or actions the D-User is performing. The services the D-User provides (i.e., UCM services) may be categorized into three types:

D-User acting on behalf of the physical user by carrying out in-network processing, such as processing data, computing tasks such as running its own applications, analysis and AI, controlling user devices and health.

D-User facilitating interactions with 3rd party entities (e.g., by providing privacy, sharing data, obtaining content from the content providers, financial transactions and establishing agreements and negotiations)

D-User interacting with the hosting network to enhance services obtained from the hosting network or 3rd parties (improve the QoS of the communication services, obtain network data and state such as loading and topology)

A hosting network operator (HNO) such as a Mobile Network Operator (MNO) may decide the type of D-User that needs to be created in the D-User platform of the Digital World, based on the services the network needs to provide to the user.

### 6.14. Hosting Platform (HOP) as an Isolated Container

In possible embodiments, a method to create an isolated Hosting Platform (HOP) for Digital Entities (DEs or D-XX) representing real entities requiring privacy may be provided. In some embodiments, the real entities represented by the DEs may comprise physical entities existing in the real (i.e. non-digital) world. In other embodiments, a real entity may comprise programs, applications or functions separate from the HOP. Some examples of real entities include physical processing devices, physical users (P-Users); P-User access device (UAD); organizations; infrastructures; buildings, one or more network functions, application servers; User Equipment (UE); UE sensors; and user applications. A platform can refer to a set of software and/or hardware components that provide a foundation upon which other applications and services can be built. In the context of the present disclosure, a Hosting Platform may comprise hardware components, such as servers including memory and processors, and software functions, such as data plane and Control/Management Plane functions, that facilitate the deployment, maintenance, communications, and management of Digital Entities. The HOP can host different types of Digital Entities (D-XX), such as digital representatives of users (D-User), of objects (D-Rep), of infrastructures (D-Inf) or of any type of entity, including software applications or business processes. In possible embodiments, the HOP may be provided as an isolated container inside the hosting network. An isolated container may encapsulate the different functions that the platform may need to run, including libraries, system tools, runtime, and settings, into a single package. The different HOPs hosted by the hosting network may thus be isolated from each other and from the underlying hosting network. A network which provides the resources for the creation and maintenance of hosting platforms for digital entities can be referred to as a “hosting network”. A request, such as a message or command, may be sent from a processing device to a hosting network, such as a 5G or 6G mobile network, to request the creation of a HOP. A request may, for example, come from a city that wants to replicate all of its infrastructure in an isolated platform, from a factory that wants to replicate a production line, or from a public utility company that wants to replicate its electricity distribution network. The hosting platform may provide the necessary resources, including memory space and processors, and functions that allow for the creation, management, maintenance of digital entities, and control access to the data and applications used by these digital entities. The hosting platform may ensure the confidentiality of operations and data accessed or generated by the digital entities.

When the digital entity is a user (D-User), the user may represent one or more of a user equipment, user application or the physical user. An in-network D-User can be used for many user-controlled and managed (UCM) services which include in-network data storage, in-network processing (e.g., run applications or specific network functions for evaluations, computing, data analysis and AI schemes), interacting with the hosting network to improve the communication services provided by the hosting network to the user, monitoring, controlling and managing user devices, and providing privacy for interactions with external application servers (e.g. data sharing, negotiations for agreements, financial transactions, content downloading, search engines, accessing the web sites).

In some embodiments, the isolated container may be a software container in the hosting network, using the hosting network hardware controlled, managed and orchestrated by the hosting network operator (HNO).

In some embodiments, the isolated container may be created using an enclave created in a confidential computing environment (CCE), such as a TEE, which is isolated from the hosting network. The enclave may create HOPs and may perform Life Cycle Management (LCM) of the functions inside the HOPs according to instructions provided. The instructions may be provided to the container's manager as a blueprint of the HOP wherein the blueprint may contain the descriptions of the functions, their interfaces and configuration attributes, descriptions of the Digital Entities that can be supported including blueprints for their creation, detailed steps for the creation, LCM and operation of the Digital Entities, resource requirements and QoS requirements for the messaging to and from the HOP functions.

In some embodiments, the method may comprise identifying different privacy levels required by the Digital Entities, including for example for D-user modules, and associated technical solutions to provide these privacy preservation levels.

In some embodiments, the HOP creation procedure may be provided.

In some embodiments, the in-network Digital Entity system architecture and HOP functional architecture may comprise the various functions and interfaces required for the HOP creation process.

In some embodiments, the isolated HOP may be provided with the capabilities to:
create its own functions (HPFs), and prepare interfaces according to a pre-prepared blueprint provided to the HOP and perform LCM for these functions,
download, install and configure computer programs, AI schemes and machine learning programs for the entity to use,
manage and control the network functions and allocate resources to various functions.

In some embodiments, methods to preserve privacy may be provided which include one or more of:
Changing the ID of an entity, such as a user or an asset, when interacting with external entities;
Encrypting the Digital Entity data moving out of the HOP; and
Keeping HOP functions isolated from the hosting network by creating the HOP inside a confidential computing environment or a TEE, wherein the isolation includes:
Preventing the hosting network from accessing data inside the HOP;
Preventing the hosting network from accessing the functions inside the HOP without the Digital Entity authorization; and
Preventing the hosting network from identifying the external entities the Digital Entity is interacting with by changing an identifier (ID) linked to the Digital Entity (ID) inside the HOP for outgoing data packets and providing a random location inside the HOP for external entities to provide responses.

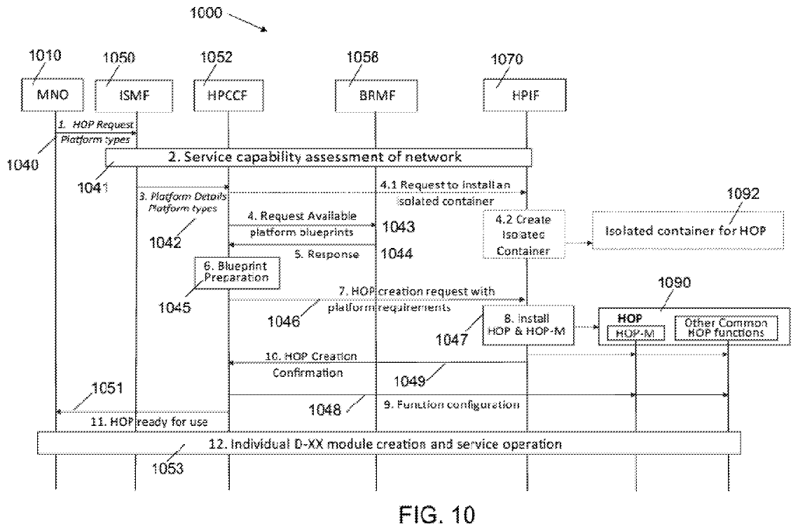

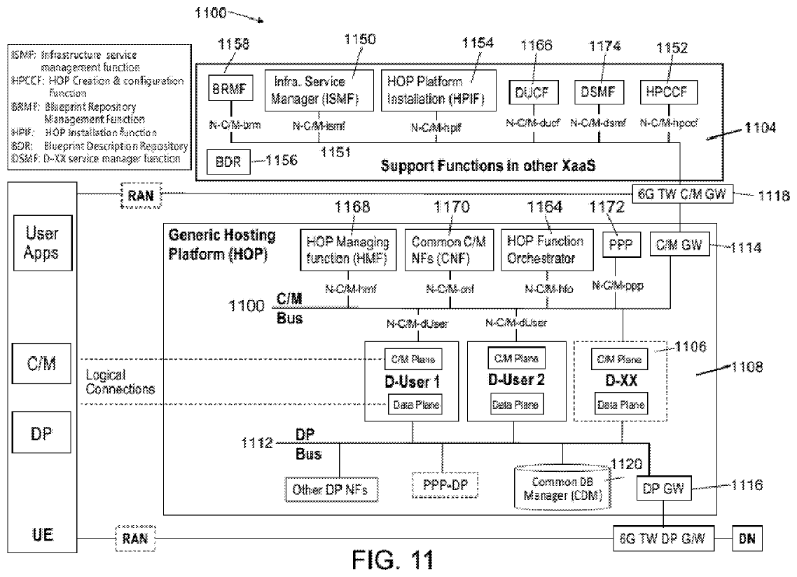

In possible embodiments, the creation of a Hosting Platform (HOP) may involve receiving a request to create or host one or more Digital Entities (such as D-Users or D-Reps) inside a hosting network, such as a Mobile Network. The request can be received at the network from a physical entity, such as a User Device or Equipment, a robot or the likes. The request can be fulfilled by the specific servers and services of the network, as defined in more detail in the following sections “HOP creation stages”, “HOP creation procedure” and with reference to FIGS. 10 and 11.

The instantiation of the HOP may be made in a container of the network. Containers, which may be provided as “Kubernetes”, may use lightweight Operating System (OS) virtualization technology, allowing containerized applications and dependent components to run in a resource-isolated process. These applications and components may be packaged into images for reuse, ensuring that containerized applications run consistently. Containers may consist in executable units of software in which application code is packaged with libraries and dependencies. Instantiation may comprise the creation of a real instance or particular realization of a template or “blueprint”, such as a class of D-Rep. To instantiate a HOP or a Digital Entity is to create an instance therefor, by allocating it resources (memory and/or processing power) and provided it with a name or label to reference it.

The HOP may be instantiated as a container with at least one Hosting Platform Functions (HPFs), where a function, or subroutine, may comprise a sequence of program instructions that performs a specific task, packaged as a unit. This unit may then be used by the HOP wherever that particular task may be performed, including for example the creation, maintenance, control and termination of a Digital Entity. Typically, the HOP comprises a plurality of HPFs, including for example HOP managing functions, Control/Management functions, Orchestration functions, a Privacy Portal, etc. Examples of HPFs are provided and explained, for example, in the section entitled “Functions inside HOP for HOP operation and Summary of HOP Functionalities to set up with the HOP platform creation”.

Access to the data associated with the one or more Digital Entities instantiated in the HOP, referred to DE data, can include data which define and characterizes the Digital Entity. For example, if the DE is a D-User, DE data may include: name, age, address, or data collected from sensors, such as heart rate, blood pressure, temperature, or location. The Digital Entities can be digital replicas of real users, such as humans or animals, but also other physical entities, such as robots, cars, and phones. The DE data can also include data relating to the services or functions used by the DE, including, for example, access to specific servers, content downloads, AI modules used, products ordered or bought, etc.

In possible embodiments, the HOP may create a Digital Entity (DE or D-XX) based on a request received from a real/physical entity, such as a person, a User Equipment, a robot, etc.

In possible embodiments, the DE may have at least one function which can be controlled by the real entity.

In possible embodiments, the architecture of the Hosting Platform may be configured such that the Hosting Network (HN) can access functions in the Digital Entities only if authorized by the Hosting Platform Functions (HPFs).

In possible embodiments, privacy of services provided by HOP to the Digital Entities are privacy protected.

In possible embodiments, the HOP may have at least one function (HPF), which may control access to the Digital Entities.

In possible embodiments, the Digital Entity hosted in the HOP may provide specific services to physical entities, such as humans, animals, User Equipment or robots using its DE functions.

In possible embodiments, when the HN is not a trusted network, the HOP may be created inside a Confidential Computing Environment (CCE). The HN can perform the installation and handover access keys to the objects (such as robots or User Equipment) and establish secure communications between object and the Digital Entities. The Digital Entities may attest the credibility of the HOP to ensure that the original trustable functions are inside the HOP and that the HN does not have access to the Digital Entities, after having established the secure communications.

### 6.15. Creation of a HOP to Install Digital Entities Inside the HOP

In the above description, the HOP is adapted to create Digital Entities therein. In the following embodiments, the methods to create a HOP capable of creating a generic NET4DW service modules (D-XX) is provided. A Digital Entity (DE), also referred to as a D-XX or D-XX module can be a D-User, a D-Rep, a D-Inf or any other DW application such as Virtual Reality (VR), Augmented Reality (AR), Mixed Reality (MR) applications. Since a NET4DW platform has D-Users, D-Reps and other D-XX modules, privacy preservation methods for the DEs may be provided.

A method may be provided for a network operator of a communication network (e.g., a mobile network, fixed wireless network, or a data network) to create an in-network digital entity (D-XX) of a real entity (such as a person, vehicle, organization, including a digital representation), wherein the Digital Entity has the capability of acting on behalf of the real entity to interact with a service provider and obtain customer services while preserving the privacy of the real entity. The method may include establishing a hosting platform (HOP) for Digital Entities inside the hosting network. The HOP may comprise one or more HOP functions that can be controlled by a customer (or end user.)

The customer may be an end user of a mobile network.

The service provider may be the network operator and the customer service may be the communication service provided by the network operator.

The service provider may be the network operator and the customer service provided by the network may comprise one or more of:
a data processing, evaluation or analysis service such as AI or ML service,
customer device monitoring or controlling service,
the customer service may be provided using an in-network D-Rep.

The service provider may be a 3rd party operator having an application server and the customer service may be one or more of:
a data processing, evaluation or analysis service such as AI or ML service,
customer device monitoring or controlling service,
the customer service may be provided using an in-network D-Rep.

The customer may be a 3rd party organisation (e.g. vertical, OTT, application server), the customer service may be the service obtained from the 3rd party by the end-users of the organisation, D-Rep may be the digital representation of the organisation and D-Rep may assist providing required in-network services to support the end users obtaining services from the organisation.

The customer may be a DW operator, the customer service may be the DW service provided to the users and devices using the DW applications and the D-Rep may be the D-XX module keeping various digital representatives and the applications functions to run the DW service.

### 6.16. Details of these Embodiments Follows

### Privacy for UCM Services

User privacy may be an important factor for users, since users currently have to share their personal data with many organisations including, for example, Over The Top (OTTs) such as Google™, Amazon™, YouTube™, etc. and other service providers such as shops, equipment providers etc., in order to get various services from those organisations.

Therefore, possible embodiments may provide a method to create a Digital Entity, such as a D-User, considering these privacy issues, and to obtain a cost effective and improved service from the hosting network. Many factors may need to be considered when creating a D-User inside a network to give the user the control and management (UCM) capabilities on the services the D-User obtains from the hosting network.

Since a D-User may act on behalf of a user, the actions taken by the D-User (e.g., analyzing and processing user data, providing a computing platform, providing AI services to the user, home control, or financial and health control) may not be exposed to the hosting network and D-User functions may need to be isolated from the hosting network. This may be important when the hosting network is not a trusted party. Depending on the type of UCM services, the isolation the D-User required from the hosting network may be different.

In addition, the hosting network may provide some added capabilities to the user when the user is communicating with 3rd parties, e.g. prevent privacy and identity leaking to the 3rd parties and to the hosting network. This may depend on the type of interaction the user is having with the 3rd parties which can include a user accessing an application server or making payments or receiving payments to/from 3rd parties.

### 6.17. Privacy Issues Solved Using D-User and a Hosting Platform (HOP)

Digital Entities, such as D-Users, may be isolated from the hosting network depending on the trust level the hosting operator would like to offer. For example, there may be a need to prevent the hosting network from accessing the digital entity data. In addition, a DE, such as a D-User, may need to be isolated from external networks accessed by the user. Furthermore, the user may need protection from malicious attacks to prevent the hosting network from accessing private user data.

Depending on isolation requirements, different solutions may be implemented. The complexity and/or cost of providing privacy to a D-User may depend on the level of trust the host is willing to provide. For example, a hosting network may offer trust levels such as those described below.

The hosting network can provide services as a trustworthy party to the user or as an untrustworthy party. Table 1 provides examples of privacy preserving levels a user may require for different types of UCM services. In order to meet those requirements, a D-User may need to be instantiated inside a separate network module which can be referred to as a ‘Hosting Platform’ (HOP).

The HOP is preferably isolated from the hosting network and the required level of isolation depends on both the trustworthiness of the hosting network and the type of UCM services the D-User is providing to the P-User. In addition, the HOP may help the user preserve privacy when accessing external servers. These cases are summarised in Table 1.

In Table 1, a trusted network (T) means that a user needs to trust the network which provides the particular service/capability to the user. On the other hand, an untrusted network (U) means the user can obtain services from the network while preserving privacy, without leaking user information to the network providing the service. Preserving privacy of the real entity by the network may be performed by 1) preventing visibility of real entity and/or DE data, 2) preventing visibility of processing of the real entity data and/or DE data or by preventing visibility of execution of specific functions of the real entity from any other entity using the Hosting Network or from any other external networks.

TABLE 1
Example levels of privacy that can be provided by the hosting network for UCM services

| | | | | | Exposure to | | | | |
|---|---|---|---|---|---|---|---|---|---|
| | Exposure to hosting | | | | External data | | | | |
| | network & | | | | Network (e.g. | | | | |
| | Trustworthiness (T/U) | | | | Server) & | | | | |
| | | | C/M | | Trustworthiness | | | | |
| Use | | Data + | Operation/ | Destination | | | User | D-User capability/ | Requirement/ |
| case | T/U | Processing | Action | Address | T/U | Data | ID | UCM service | Solution |
| 0 | U | No, | Yes | Yes | T | Yes | Yes | Network provides | Current system. |
| | | Encrypted | | | | | | transport service. | No privacy |
| | | | | | | | | | solution other |
| | | | | | | | | | than UE |
| | | | | | | | | | filtering. |
| 1 | T | No, | Yes | Yes | U | Yes | No | Can access 3^{rd} | ID change by the |
| | | Encrypted | | | | | | party servers | host. |
| | | | | | | | | anonymously. | |
| 2 | T | Yes | Yes | Yes | U | FHE | No | User data can be | ID change and |
| | | (DPF) | | | | | | processed inside | data de- |
| | | | | | | | | the network (data | privatized by |
| | | | | | | | | accessible to host) | host. |
| | | | | | | | | as needed by the | Data processing |
| | | | | | | | | user. | done by host. |
| | | | | | | | | USER ID change | |
| | | | | | | | | and data de- | |
| | | | | | | | | privatized by host. | |
| 3 | U | No | Yes | Yes | U | FHE | No | D-User can process | User data is not |
| | | | | | | | | data. Host does not | accessible to |
| | | | | | | | | have access to user | host. |
| | | | | | | | | data. | |
| 4 | U | No | Yes | No | U | FHE | No | Can access 3^{rd} | HOP to have a |
| | | | | | | | | party servers | minimum |
| | | | | | | | | anonymously and | number of D- |
| | | | | | | | | without the host | Users (multi-D- |
| | | | | | | | | knowing which | User platform). |
| | | | | | | | | user accessed the | HOP changes |
| | | | | | | | | 3^{rd} party server. | the USER-ID. |
| 5 | U | No | No | No | U | FHE | No | Same as above. | The operations |
| | | | | | | | | Host does not | inside the HOP |
| | | | | | | | | know the | are controlled by |
| | | | | | | | | operations a user is | the user and the |
| | | | | | | | | taking inside D- | hosing network |
| | | | | | | | | User. | is unaware of |
| | | | | | | | | | them. |

### 6.18. HOP Requirements and Solutions/Use Cases

The HOP requirements and solutions for the cases indicated Table 1 are described below.

6.18.1. Current Model (No D-User, No Privacy from 3rd Parties)

Current mobile networks act like transport systems for the user to access the external data networks/servers. Data may be encrypted end-to-end so only the user device and the application server have access to data and control of data. A user can filter the data they share with the 3rd parties but, depending on the service they obtain, they might have to provide, for example, information about their identities and other valuable information. In addition, in current mobile networks, a user may not have any control or management over the services the user obtains from the network (i.e., no UCM service can be operated).

### 6.18.2. Use Case 1: Provide Anonymous Access to 3rd Party Servers (Service Providing Network May be Trusted)

In a possible embodiment, the mobile network may hide the entity identity (ID change) so that users may access external servers anonymously. The network is trusted to keep access sites/server descriptions, other than for police tracking events. In this case, the HN is trustable by the entity associated with the corresponding DE.

Requirement: An external server should not be aware of which digital entity has accessed it.

Solution: The hosting network may perform an ID management function (IDMF) to change the source ID and the return address of the digital entity hosted in a HOP. However, the hosting network may know what server the digital entity has accessed (privacy leaks to the hosting network). The hosting network may include a Hosting Network Function (HNF) which facilitates access of the one or more DEs to access external servers anonymously by executing a IDentification Management Functions (IDMF), which change source identifiers (or source ID) s and/or response addresses associated with the one or more DEs. For example, the source ID and response addresses may correspond to IP addresses that could be used to trace back the identity of the Digital Entity, such as D-Users.

HOP requirement: The HOP may be an isolated network function module created using the infrastructure of the hosting network.

6.18.3. Use Case 2: Network Aware in-Network Processing (D-XX Exposed to the Trusted Network)

In a possible embodiment, processing data inside the hosting network may enable many services for an entity, such as AI services or service optimization solutions. The hosting network may provide the services but there is a risk of data and processing details being exposed to the hosting network.

Requirement: The Hosting Network may provide a data processing function (DPF) for the entity.

Solution: The host may provide a DPF for the entity. For example, one HNF of the hosting network may process the DE data (i.e. D-XX data, such as D-User data) inside the HOP by performing Data Processing Functions (DPF) inside the HOP. In this case, DE data (payload) is exposed to the hosting network but protected from external entities. The hosting network can additionally provide entity ID change similar to case 1, to protect the entity identity from 3rd parties, but the hosting network may be aware of both the external server address and the payload.

HOP requirement: The HOP may be an isolated network function module created using the infrastructure of the hosting network.

6.18.4. Use Case 3: Network Unaware of in-Network Data Processing (D-XX Isolated from the Untrustworthy Hosting Network)

Unlike in case 2, DE data can be processed inside the hosting network without exposing DE data to the hosting network. Anonymous access to external/3rd party servers can be provided additionally as in case 1. However, the hosting network may be aware of the external server address).

Requirement: The Hosting Network may need to provide an isolated data processing function (DPF) inside the hosting network to the entity and ID change function to access external servers anonymously.

Solution: The Hosting Network may provide a DPF or a Digital Entity, such as a D-User, inside an isolated enclave.

HOP requirement: The HOP may be an isolated enclave in a confidential computing environment (CCE). A HPF of the Hosting Network (HN) may prevent the HN from accessing the DE data by having the container in which the HOP is instantiated provided in a Trusted Executive Environment (TEE), corresponding to a confidential computing environment (CCE) located inside the HN. The container may thus be isolated from the operating systems (OS) of the HN. The HPF may thus prevent the HN from accessing the data of the digital entity (DE data) when the DE (or D-XX) processes data inside the HOP or when the DE (or D-XX) shares DE data (or D-XX data) with other entities external to the HN.

6.18.5. Use Case 4: Access to 3rd Parties Anonymously (Network Unaware)—D-XX Isolated from Untrustworthy Hosting Network)

Anonymous access to external/3rd party servers without exposing external server address to the hosting network. In addition, host-unaware in-network data processing can be done similar to case 3.

Requirement: The Hosting Network may need to provide an isolated IDMF (not accessible to the hosting network) inside the hosting network to the entity.

Solution: The Hosting Network may provide an IDMF inside an isolated enclave. However, in order to carry out ID changes without knowledge of the hosting network, a minimum number of digital entities should be hosted in the isolated enclave, e.g. Multi-D-User platform. In addition, the hosting network can do in-network processing inside the enclave as in Case 3.

HOP requirement: The HOP may be an isolated enclave in a confidential computing environment (CCE) which can create at least K number of Digital Entities as the K-anonymous requirement described in L. Sweeney. “k-anonymity: a model for protecting privacy”. International Journal on Uncertainty, Fuzziness and Knowledge-based Systems, 10(5), 2002; 557-570 which is hereby incorporated by reference in its entirety. In such embodiments, the HOP may have a minimum number of DE. For example, the K-anonymity model requirements proposed can be used to anonymize user communications to/from DNs (i.e., hosting network cannot know which user inside the HOP communicated with the DN). The K-Anonymity requirement can be summarised as “for every combination of identifying attributes in a dataset, there are at least “K minus 1” other people with the same attributes”. Therefore, the source ID may be changed with a randomized ID and also the return address may be randomized with a randomized location.

### 6.18.6. Use Case 5: Network Unaware Operations by the D-User

This case is similar to use case 4, but additionally, the hosting network is not aware of the type of operations the digital entity performs for its services (i.e. the services obtained by the entity are hidden to the hosting network).

Requirement: The Hosting Network may need to provide an isolated data processing function (DPF), an isolated IDMF and entire user service functions inside the HOP.

Solution: In addition to above case 4, Digital Entity (such as D-User) related functions are completely placed inside a multi-DE platform, e.g. a separate slice of the network is provided for the multi-entity hosting platform. A slice may refer to a logical network segment that is dynamically created to cater to specific service requirements, traffic types, or user groups within the broader physical network infrastructure. Once the HOP is created, the HOP may be given the capability of independent operation. For this purpose, when the HOP is created, a HOP manager function (HOP-M) may be created inside the HOP which can do the LCM DE (e.g. creation, modification and termination of Digital Entities) and common functions needed for the interaction of the DE functions with entities outside the DE (e.g. other platforms inside the HOP, hosting network functions, P-User and P-User devices, 3rd party servers), privacy preserving functions when a D-User communicating with external entities.

HOP requirement: The HOP may be provided as an isolated enclave in a confidential computing environment.

### 6.19. Summary of Use Cases 1 to 5

In above use case 1 and use case 2, the hosting network can provide the UCM services described but the entity privacy is leaked to the hosting network. For example, an exposed D-User, e.g., using an infrastructure managed and controlled by the hosting network, can be used for these services.

In use cases 3, 4, and 5, different UCM services may be provided by using a DE installed inside the hosting network without entity functions or entity data being exposed to the network according to the privacy requirements for those cases.

Therefore, there may be at least two options for a network operator to provide services to digital entities.

### 6.19.1. Hosting Network Provides DE Services as a Trustworthy Entity (Cases 1 and 2):

In this case, only the entities (such as users) who can trust the hosting network would be interested in obtaining a service which limits the hosting network's ability to serve the general public. The hosting network may not need to provide strict isolation from the hosting network although it may have to provide full protection to the DE data and DE operations from exposing them to external entities (e.g. data consumers, servers, etc.) who interact with the DE or entity. In addition, Digital Entities may need to be isolated from each other to protect their privacy. Furthermore, access to functions inside the HOP may be access-controlled using a GW in the C/M plane and a GW in the DP plane. The hosting network may use its own infrastructure to create an isolated software container (a HOP) for the DE and the hosting network may not need to provide a TEE like hardware isolation since hosting network is trustworthy. A container may consist of a standard unit of software that packages up code and all its dependencies.

6.19.2. Host Provides D-User Services as an Untrustworthy Network Where Users do not have to Trust the Hosting Network (Cases 3, 4, and 5):

In this case, the hosting network may have to perform additional actions to isolate the DE from hosting network in which the HOP is provided. Therefore, the HOP may need to be created inside a confidential computing environment created inside the hosting network such as a TEE, and be preconfigured to be able to create the necessary functions inside the HOP and interact with the entities requiring DE services. In this case, hardware portion of the HOP may be created with a platform manager inside the HOP which may be able to create the other functions and the required interfaces for those functions.

In both cases, the DE should be isolated from each other and also privacy preserving techniques may need to be established when accessing the external servers. Isolation from the hosting network may be required for the cases 3, 4 and 5.

### 6.20. HOP Placement

In possible embodiments, the hosting platform (HOP) can be placed inside a mobile network (MN), e.g. Radio Access Network (RAN), Multi-Access Edge Computing (MEC) network, or Core Network (CN), or it may be placed in any type of data network.

Keeping the HOP inside the mobile network (MN) may have many advantages compared to keeping it in a data network because:
Keeping the HOP closer to the entities (such as users) reduces the delay between the entities and their digital twin/digital entity;
All communications of a mobile go through the wireless network and therefore the wireless network is in a better position to provide services to digital entities. In contrast, a user has many options to choose a host in the data network and the communications with other data networks would not go through the selected host and selected host cannot provide all the services that a wireless network may provide;
When the host is located in a data network, the user might not have much visibility of the methods used by the host for preserving privacy because a host in the cloud may not be trustworthy as a network provider providing the mobile access to the user.

The general approach to the creation of a hosting platform (HOP) and generic hosting platform architecture is described below.

### 6.21. Generic HOP High-Level Architecture

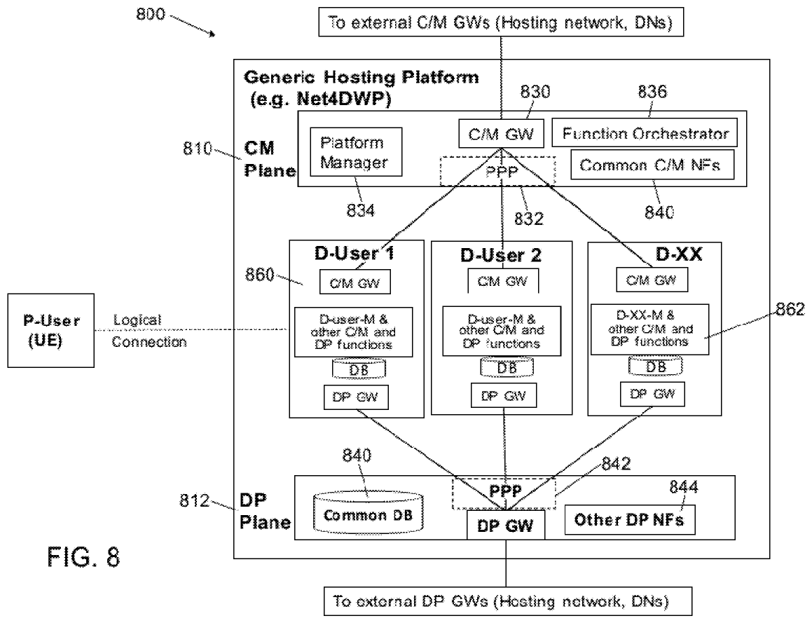

A high-level architecture of a generic hosting platform 800 is provided in FIG. 8. Some of the HOP Network Functions (HPFs) may include:

C/M plane functions 810 may be split into the following functionalities:

C/M gateway 830 which controls incoming and outgoing messages of internal C/M functions (access control, security and isolation)

C/M plane privacy preserving portal (PPP) 832 which may be included in the C/M GW

HOP manager function (HMF) 834

HOP's internal function orchestrator (HFO) 836

Common C/M network functions (NFs) 840 supporting operations of the Digital Entities (D-Users or any type of D-XX) 860.

DP functions 812 may also be split into a common database 840, PPP 842 and other DP NFs 844 to support operations of the Digital Entities (D-Users or any type of D-XX).

More details of these functions are provided later in this document. In the present disclosure, a gateway may refer to a network element that serves as an interface between different types of networks or protocols.

In addition to D-Users, the HOP 800 can host other types of Digital Entities (i.e. DE or D-XX) for any digital representations of real objects such as infrastructure (D-Inf) or organizations. The HOP C/M functions, such as Platform Manager 834 and Function Orchestrator 836 are for the coordination of the D-Users and other DEs. Similarly, there may be common DP processing functions 844 and data storage 840. Each DE or D-XX may have its own specific functions for internal control, management and data processing which are isolated from the hosting platform via specific gateways (i.e., C/M GW or DP GW). A Digital Entity (D-XX) function, or DE function, can be referred to as a functional block of code executable by one or more processors, within the Digital Entity (D-XX), with predefined external interfaces and behavior, to receive, process and transmit data packets. Examples of DE functions include C/M Plane functions and Data Plane functions. In possible embodiments, access to the DE Functions executed by the DEs hosted in a HOP provided by the network is controlled by a Hosting Network Function (HNF) of the hosting network.

### 6.22. Overview of D-User Creation and UCM Service Establishment

As mentioned above, in order to provide UCM services, Digital Entities that are for digitally replicating users, i.e., D-Users, may be created inside a hosting network with the required functionalities. D-User functionalities may be isolated based on the type of UCM services being used by the user. Therefore, a D-user may be created inside a container, as an isolated software module, inside a hosting network. A container is a standard unit of software that packages up code and the code dependencies so that applications may run quickly and reliably in the hosting platform (HOP).

Containers may run on the same OS as the OS used for the hosting network servers, which results in weak isolation from one container to the other, and also from relative to the hosting network. In this document the term ‘software container’ is used for such a container. There are additional protection methods to secure some of the functions of given digital entity from the other containers in the same hosting platform, but a software container may not be fully isolated from the hosting network.

An enclave may be a container which provides hardware isolation in terms of having a protected memory region that provides confidentiality for data and code execution. An enclave may be an instance of a Trusted Execution Environment (TEE) which is secured by hardware. Therefore, it is referred to as a hardware container in this document. An enclave can also be run on its own CPU separate from the CPUs used by the hosting network. An enclave can also be considered as a virtual machine (VM).

Therefore, a hosting platform (HOP) for a Digital Entity, for example a D-User, may be created using a software container or a hardware container (an enclave) based on the privacy level required by the entity.

A hosting platform (HOP) can be an exclusive platform for a single D-User, a platform for multiple D-Users (Multi-D-User Platform). This configuration of the HOP is also possible for any type of digital entity, i.e., a HOP can host a single DE or multiple DEs, depending on privacy requirements for the DE.

In order to support a multi-DE platform or NET4DW platform, additional layers of remote attestation may be necessary. First, the hosting network may have access to the HOP. Secondly, when the HOP creates the DE (D-XX) and connects it with the DE (D-XX) operator (in the case of a D-User, the end-user is the operator), the DE operator should be able to perform a remote attestation of the DE to gain confidence in the security and integrity of the DE. This ensures that the hosting network cannot access the DE hosted in the HOP, in cases where the DE code is provided by a vendor, and the vendor can attest the DE integrity during remote attestation. In some embodiments, each DE may be provided in an enclave, in addition to the HOP being provided in an enclave of the hosting network.

When a Host Network Operator (HNO) decides to provide D-User services, the HNO may first create a HOP platform with a HOP manager which is capable of instantiating the D-User portals when requested by an HNO network function. Some HNOs may not use a common HOP, such as a NET4DW or Multi-D-User platform, to create D-Users and may create individual D-User platforms as and when needed. In this case, each D-User or D-XX module may have their own enclaves.

Accordingly, the UCM service establishment may require the following procedures:

A hosting platform creation which may establish D-User modules and configure the D-Users.

Establishment of a D-User (e.g. when requested by a user or any network function, or prepare several D-Users of different types beforehand and have the D-User ready whenever they are needed).

Establishment of particular UCM service capability

A brief description of these procedures is provided below.

### 6.23. The Hosting Platform Creation

When HNO decides to provide services to digital entities, such as D-User services to D-Users, the HNO may first create a HOP platform 800 provided with a HOP manager 834, which is capable instantiating DEs (D-XX), including for example D-User portals when requested by the HNO CPFs or the HNO's D-XX service manager (DSMF). HOP platform is created inside the HNO network but isolated from the network so that the hosting network cannot access the digital entity data inside this platform. It may be created in at least two ways.

One possibility is that an HNO uses its own infrastructure and creates an isolated software container for the hosting platform (HOP). In this case, the internal function creator may not be inside the hosting platform (HOP). The Platform Manager 834 can manage the HOP NFs and associated resources using APIs. Without hardware isolation, this option may not be the preferred option by operators or end-users of the digital entities.

Another possibility is that an HNO may use an enclave, such as a trusted executive environment (TEE), which is preconfigured to be able to create the necessary functions inside the hosting platform (HOP) and interact with the DE operators or end-users. In this case, this hardware hosting platform may be a standard platform with a Platform Manager 834 which is able to create the other functions and the required interfaces.

### 6.24. Creation of a Digital Entity (D-XX)

The following paragraphs explain the creation of a digital entity (DE or D-XX) in general terms, and also refer to the specific case of creating a digital entity for a user (D-User). As explained above, in the present application, a digital entity (also referred to as an entity replica or a digital twin) represents or replicates any type of entity, whether for an organization, an object, a process, an application, a set of objects, or a user. The creation process of these different entities is similar, and similar creation functions can be used. The creation of a user entity (D-User) represents a special case of a digital entity creation.

The creation of a D-User inside a HOP may be initiated either by a user, a network entity or another D-User. In possible embodiments, a D-XX service manager (DSMF) may request the HOP to create a D-XX module or assign a D-XX module already created in the system to a particular user. These are several ways this can be performed.

A D-User may be created when the user or a network entity requests the creation of the D-User, such as after a user has subscribed for a D-User. When a message is received by a digital entity service manager (DSMF), from the user or from a HNO's network function, the DSMF may transmit the D-User creation request to a HOP function (e.g. HOP Manager function) with the type Digital Entity to be created (for example, a D-User with strict privacy requirements). There can be different types of Digital Entities, and different types of D-Users, as described in this document. The request may be generated by a network function when a D-User subscribed to a particular D-User type or a UCM service. The HOP manager function may create the required D-User module using its Function Orchestrator 836, when an enclave is used for the HOP, or by a HNO's Function Orchestrator, when a software container is used for the HOP. Once D-User is created, a secure link may be established between the user and the D-User for further communication and to establish D-User services.

The process may be similar for other types of digital entities. In the general case where the creation of a Digital Entity is requested, a service provider of Digital Entities (the network operator or an external service provider), requests the Digital Entity creation from the DSMF. The DSMF may then request the HOP to create the Digital Entity and the HOP may create it using its Function Orchestrator 836.

The hosting network and/or the HOP may create and store one or more digital entities, such as D-User modules, ready to be used. Since the creation process of digital entities (which include creation of various functions and interfaces and configuration of those functions), may take some time, if users or the hosting network needs to create a D-User without much delay, the hosting network may create and keep several D-Users in standby mode, without assigning them to end-users. Other types of digital entities may also have additional unassigned D-XX so that, when a request is received, the HOP can assign these digital entity modules quickly. The number of DEs to be kept in a semi-active mode may depend on rate of requests received for the creation of D-XX. The preconfigured DEs may be kept inside a single HOP or in different HOPs. Pre-deployed and preconfigured D-Users may be of different D-User types to suit different types of user requirements. When preconfigured D-Users are available, upon receiving a request, the hosting network can quickly assign them to a user as specified in the request. However, there may be some additional configuration steps that are needed before the D-User is fully operational.

A digital entity may be created dynamically (e.g. in visiting networks), for example when a user wants to obtain a D-User service (i.e., a UCM service) or when a service provider wants to provide a new D-XX service. In the case of a D-User, a user or a network function may request a D-User Creation Function (DUCF) in the control plane of the hosting network to create particular D-User type or allocate an existing D-User container to the user and user can use the UCM service after the creation. In the case of a D-XX module, the service provider may send a request to a D-XX creation function (DXCF—An appropriate function for that D-XX type), to create a D-XX module or allocate an already available D-XX module for this service.

### 6.25. Establishment of a Specific D-XX Service(s) (e.g. UCM Service or D-User Service)

Once a D-User is created, additional UCM services may be requested by the user. This may be done by making an additional subscription to the service layer function (i.e. DSMF), or by making a dynamic request to the control plane function (i.e. DUCF), or making a dynamic request to the HOP or D-User management function. However, as mentioned above, a user can request to create a UCM service without the creation of the D-User and, at that time, the network treat it as a request for a specific type of D-User with that UCM service and create the D-User as well.

For a given Digital Entity (D-XX module) there can be different types of services. A D-XX service operator may need some operations or services from the D-XX module and may need to configure them. In addition, some D-XX service providers such as a Mobile Virtual Network Operator (MVNO) may have end users or end devices which obtain direct services from the D-XX modules. Both of these service types may be included in the D-XX configurations.

A user or a hosting network function (HNF) may request the establishment of a specific UCM service. The request would be received by D-User creation and configuration function (DUCF) inside the HNO. The DUCF function may be comprised in a more general DXCF module, where a DXCF module is configured and adapted to create services to digital entities, and the DUCF function is especially adapted to provide D-User related services. If D-User is not already created, the method may first follow the steps of the D-User creation process explained above. Once a D-User is available, the DUCF may request the establishment of the UCM service either from the HOP or from the D-User, depending, for example, on the privacy requirements and specific implementation. Similarly, for the D-XX services, the request may come from the D-XX service operator or a D-XX service operator's client device to the (D-XX creation and configuration function) DXCF and DXCF may request the establishment of the service.

In certain cases, the UCM service establishment may need to be performed transparent to the hosting network, i.e., such that the UCM service establishment is performed without the hosting network being aware of this new UCM service. In this case, D-User manager is provided with the required capabilities and also may have authority to request the creation of new hosting network functions, HOP functions (HPFs), or configure them by obtaining authorization from the network. When the HOP manager creates the D-User, these capabilities may be provided to the D-User manager. Similarly, for the D-XX services, if the D-XX service operator requires to have fully independent operation, various D-XX services may be established by the service provider directly requesting the D-XX (e.g., D-XX manager function). For this purpose, the D-XX capabilities may be provided to the D-XX manager during the establishment of the D-XX module and the hosting network functions may be configured to receive and execute specific requests from the D-XX manager required for the D-XX service establishment and operation.

### 6.26. Hosting Solutions to Create a D-User with Different Isolation Requirements

In order to meet the requirements for use cases such as those described above, the following steps may be implemented.

Each D-User may be isolated from D-Users of other users but they can share the same network functions. In this case, a D-User may use a software container providing added functions to isolate the D-User from other D-Users. When a user has access to multiple D-Users, it may not be needed for the D-Users to be isolated from each other and the D-Users may share common functions for their operation.

A HOP may be created inside an enclave isolated from the hosting network (i.e. even the hosting network may need to obtain permission to access functions or data inside the enclave). This may be useful, for example, for use cases 3, 4, and 5 described above. For these cases, an isolated confidential computing platform such as a TEE (or CCE) may be used.

A HOP platform may be used for multiple D-users in order to be able to perform ID changes to hide the identity of the end-users even from the hosting network when communicating with external devices. This may be useful, for example, for use case 4. One hosting network function (HNFs) within the Hosting Network may ensure that the Hosting Network cannot track the external servers accessed by a specific Digital Entity (D-XX) by deploying the Hosting Operations Platform (HOP) as a multiple DE-HOP. When the HOP hosts multiple Digital Entities (DEs), it may become impossible for the HOP to track which specific DE has accessed which external server.

A HOP may also keep a minimum number of DEs, such as D-Users, inside the HOP. For example, the K-anonymity model requirements may be used to anonymize user communications to/from DNs (i.e. hosting network cannot know which user inside the HOP communicated with the DN). The K-Anonymity requirement can be summarised as “for every combination of identifying attributes in a dataset, there are at least ‘K minus 1’ other people with the same attributes”. Therefore, the source ID of messages sent to the DE may be changed with a randomized ID and also the response address of messages sent by the DE to the user may be randomized, with a randomized location (such as random or encrypted IP address).

The confidentiality requirements of a D-User may also be met by having one, or a limited number of D-Users, in separate enclaves. The communications to outgoing and incoming ports of each of the separate enclaves to third parties can be configured to transit through another isolated enclave of the hosting network. This isolated enclave can be configured to perform random ID changes, thus preserving the confidentiality of D-Users with respect to third parties. In such possible embodiments, it is possible to maintain confidentiality specifications for a D-User even with a limited number of D-Users in a HOP. Once the HOP is created, the HOP may be given the capability of independent operation. This may be useful, for example, for use case 5 described above.

For this purpose, when the HOP is created, a HOP manager function 834 (HOP-M) may be created inside the HOP. The HOP-M 834 may be capable of doing the LCM for D-Users (e.g. creation, modification and termination of D-Users). The HOP-M may also be capable of doing common functions needed for the interaction of the D-User functions with entities outside the D-User (e.g. other platforms inside the HOP, hosting network functions, P-User and P-User devices, 3rd party servers), privacy preserving functions when a D-User communicating with external entities.

Metaverse or digital world (DW) applications may use different types of digital entities (D-XX) and privacy preservation may be required for the Digital Entities (D-XX) as well as for the DW application operations. In particular, the DW operations may need to be protected from the hosting networks. The hosting platforms (HOP) discussed herein can be used for providing in-network DWs as well. DWs may consist of D-Users, various D-Reps such as D-Infs and various other applications, such as VR or AR applications.

### 6.27. System Architecture for in-Network HOP Creation

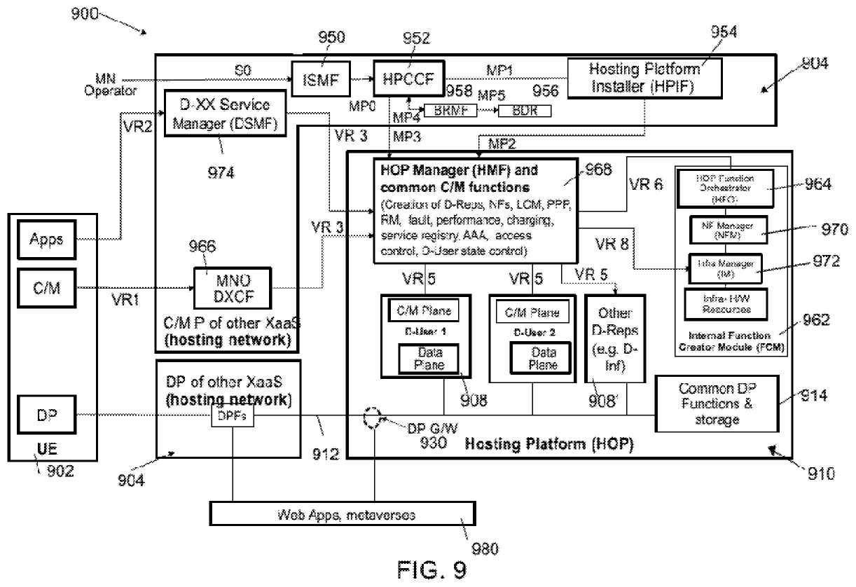

FIG. 9 shows an exemplary system architecture 900 which also includes HOP creation functions and various interfaces. Note that these interfaces (VR1-VR5, MP1-MP5) are logical interfaces and they are connected through a common bus under the SBA architecture which is shown in FIG. 11. A user may connect, via a User Equipment (UE) 902, to the hosting network 904 through a radio access network (if the hosting network is a core network) or through both a RAN and CN (if the hosting network is a data network in the cloud) which is not shown here as these interfaces are logical interfaces. The logical interfaces are displayed to clarify the relationship between the different functions involved in creating the HOP.

FIG. 9 further shows exemplary data plane (DP) 912 connecting the UE 902, the hosting network 904, the Digital Entities (D-User), (D-Rep) 908′, the HOP DP functions 914 and external data networks and servers 980. As can be seen in FIG. 9, data communications between the HOP 910 and the external servers 980 may go through a HOP DP GW 930. This configuration is given as an example only and may vary depending on how accesses to and from the HOP data plane are implemented.

The HOP creation process may start with a network operator determining the type of HOP to create, for example based on the type of Digital Entity (D-User or other) and based on the UCM services to be provided. Then, the network operator may provide the Infrastructure XaaS service Management Function (ISMF) 950 the hardware and software requirements for the HOP based on the determination. The ISMF 950 may further evaluate or confirm the resource requirements and the capability of the hosting network in determining the type of HOP. The ISMF 950 may then request that the Hosting Platform Creation and Configuration Function (HPCCF) 952 create the HOP. The HPCCF 952 may use the platform installer (HPIF) 954 to create the HOP and instantiate the initial functions needed to create and manage Digital Entities (including for example D-Users and/or D-Reps). The initial functions may include HOP Network Functions (HPFs). The HOP Network Functions (HPFs) may include various functions, including a HOP Manager Function (HMF) 968 which can be configured to create the Digital Entities 908, 908′. The HPCCF 952 may configure those initial functions and provide blueprints for different functions. Blueprints for different functions may be stored in the Blueprint Description Repository (BDR) 956. The Blueprint Description Repository Management Function (BRMF) 958 may obtain the required blueprints according to the HOP creation request, via the HPCCF 952, through interfaces MP4 and MP5, and send the blueprints to the HOP manager 968 to be used, for example, for creation of specific types of Digital Entities, such as D-Users or D-Reps. These initial functions may include the HOP managing function (HMF) and other common Control and Management functions.

The exemplary HOP 910 shown in FIG. 9 also has an internal function creator module (FCM) 962 which may consist of a HOP Function Orchestrator (HFO) 964 to instantiate additional functions inside HOP. An orchestrator typically refers to a component or service responsible for coordinating and managing the deployment, configuration, and operation of multiple services or components. The HFO 964 may use infrastructure provided for the HOP (for example, the memory allocated to a container) for this purpose and an infrastructure manager (IM) 972 may manage the infrastructure. The created HOP network functions (HPFs) may be managed by a network function manager (NFM) 970.

In embodiments where the HOP uses resources of the hosting network infrastructure, the entire FCM module 962 may be kept outside the HOP, and the Network Function creation and other LCM operations may be done by requesting the external FCM 962 to create the HPFs of the HOP. In another option, HFO 964 may be inside the HOP and other functions of the FCM 962 may be placed outside the HOP.

When a request is made by a user, a network entity, or any other authorized entity to create a DE, the request may be received by the D-XX Creation Function (DXCF) 966. The DXCF may then inform the HOP manager 968 to create a container for the DE with a D-XX manager (D-XX-M) 862 (identified in FIG. 8) and certain essential functions, such as the access control function. The instantiation of the other functions required for the DE may be done either by the D-XX-M 862 or the HOP manager depending on the required independence of the Digital Entity from the HOP. Note that if each Digital Entity is created inside a separate enclave, a separate D-XX-M is not required and all the D-XX-M function describes in this document may then be done by the HOP Management Function (HMF) 968. Each Digital Entity (D-XX) may comprise D-XX functions accessible to the P-Users via a P-User access device (UAD) or via a UE, without knowledge or awareness of the HN. In other words, the functions, applications and data of the D-XX hosted in the HOP may not be visible to the Hosting Network. The HN may not have access to HOP functions nor to the D-XX data or D-XX operations. The HN is blinded and unaware of the functions and operations performed by the HOP or in the HOP. In some cases, functions inside the HOP may be provided by the user or by an external server (3rd party) trusted by the user.

To make a request to the DSMF 974 the VR2 interface in FIG. 9 may be used. The request may include the Digital Entity or UCM service type and date and time by which the Digital Entity is needed. To make a dynamic request to the DXCF 966, a user control plane function may use the VR1 interface, indicating the Digital Entity or UCM service type, a user ID and subscription details. The DSMF 974 or the DXCF 966 then make a request to the HOP manager 968 (after the authentication of the request and authorization) to create the required Digital Entity for the requested service, using the VR3 interface. The HOP manager 968 will then create the Digital Entity with a D-XX manager (D-XX-M) 862 and establish a secure link between the D-XX-M and the HMF 968 to configure the Digital Entity (such as D-User 1, D-User 2 or D-Rep) via interface VR5 and any other appropriate functions.

### 6.28. HOP Blueprint

According to possible embodiments, a HOP blueprint may be comprised of one or more of the following aspects.

A HOP blueprint may include the type(s) of Digital Entities (D-XX) that may be created inside the HOP and the Digital Entity blueprints. For example, there may be several D-User types that may be created with associated UCM services. Therefore, the procedures for all the D-User types and UCM service that may be hosted and supported by the HOP may be specified. The blueprints may also include the required functions needed for each service.

A HOP blueprint may include an indication of the maximum number of Digital Entities (D-XX) that may be supported by the HOP. This number may be determined based on the different types of Digital Entities. For example, a HOP may support 5 D-Reps, 3 D-UEs, or a certain combination of them. The number may also be defined based on the DE applications that may be available for execution by the DE, including for example AI algorithms/methods/environments, tasks, services and so on.

A HOP blueprint may further include a procedure to create new types of Digital Entities (D-XX).

A HOP blueprint may include common functions of the HOP and their configurations and associated processes.

A HOP blueprint may include the procedures the HOP manager function (HMF) may perform after the HOP is created. For example, procedures for the establishment of secure communication with the Hosting Network, such as HPCCF, DUCF, DSMF as well as procedures for hosting network function discovery processes including, for example messaging structure and ingress and egress ports to use when communicating on the hosting network C/M and DP bus.

A HOP blueprint may further include the functions and procedures associated with the HOP managing function (HMF).

A HOP blueprint may further include resource requirements for the Digital Entity (D-XX) which may include, for example, storage, computing and link capacities for different interfaces. Computing resources may include the number of CPUs or GPUs and their speeds and allocated % of CPU power from the computing engines and RAM memory requirements. Storage requirements may include storage size and access speeds.

A HOP blueprint may further include the QoS characteristics (e.g., latency, packet loss, data rate, etc.) of the links between the Digital Entities and the associated real entities such as users, devices etc. This may include, for example, link requirements for the links between the expected Digital Entity (D-XX) and the network functions in the HOP or the hosting network. (e.g., for a D-User, the link between D-User and the user, links from D-User to other networks and HOP functions such as Hosting Platform Creation and Configuration Function (HPCCF), D-User Creation Function (DUCF), Infrastructure Service Management Function (ISMF)).

If a Digital Entity replicates of multiple physical devices, e.g., in the case of a Digital Representation (D-Inf) of a Base Station (BS) composed of processing units, antennas, cables, the links between the digital representations (D-Rep) of these assets are also considered in the HOP blueprint.

The HOP and/or the Digital Entity (D-XX) characteristics may include:

Guaranteed/maximum downlink throughput

Delay tolerance

Energy efficiency

Group communication support

Mission-critical support

Maximum number of concurrent sessions supported by the HOP

Positioning support and related positioning methods and associated functions

HOP may have a service area, country, location, etc. based on where it is located

Priority level: When resources are allocated to multiple D-XX on the same HOP, each D-XX may have different priorities. For example, a mission critical D-XX may have priority over many others, or a D-XX with delay-critical analysis, e.g., X-R, may have priority over other D-XX.

Supported Real-entity mobility level

Edge and master HOP/D-XX support

Mission management support or support for mission-based traffic

Support for in-network processing, e.g., traffic, routing solutions, resource allocation, algorithms, privacy settings and so on

The Generic Characteristics of the digital entities (D-XX) may include:

Age of information tolerance, limits, requirements

Synchronization requirements

Accuracy level of simulation/predictions

Efficiency of resource usage, e.g., limits on accuracy vs. CPU usage/data amount/training time

Granularity level of D-XX, e.g., a BS being represented as one black box, or a BS being represented as an association of several entities, e.g., antennas, cables, processors.

### 6.29. HOP Creation Stages

The HOP creation may comprise at least three stages:

Planning, design and preparation stage

Creation of a HOP container (the container is available to be used)

Creation of the complete HOP (by including required functions according to the requirements and ready to create Digital Entities (D-XX) when requested).

First there may be planning, design and preparation stage. Then, a generic basic HOP with all the necessary functions (e.g., HMF) to create any type of Digital Entity can be considered as the initial HOP. After the initial creation of a HOP with an HMF function, several more steps may be needed to have the HOP in an operational ready state. These states of HOP are further described below.

### 6.29.1. Planning, Design and Preparation Stage

In this stage, a network operator may design, plan and prepare the blueprint of the HOP which describes the all the functions, their configurations and interfaces needed with all the workflows required for the operations. The resource requirements of the HOP may also be assessed. Moreover, isolation requirements for the HOP may be determined. For instance, this may involve deciding whether separate hardware, such as an enclave, needs to be employed, especially in cases where the Hosting Network (HN) is untrusted. Alternatively, internal infrastructure of the hosting network, such as isolated software containers, may be utilized, such as when the HN is trusted.

6.29.2. Secure Container Ready Stage (HOP Container is Created with at Least a HOP Management Function)

In this stage, which may be referred to as the “basic HOP stage”, the hosting network may have allocated a separate container for the HOP, either using a TEE, such as a confidential computing environment (hardware container) or using a software container with internal hosting network infrastructure. Providing an enclave for the HOP may include, acquiring hardware from a vendor with access security keys, installing it and setting it up. Once a container has been allocated for the HOP, at least a HOP management function (HMF) may be created inside the HOP and a secure communication link is established between the HMF 968 and a hosting network function (HPCCF) 952 wherein the HPCCF 952 has access to the HOP 910. This means that the HOP 910 may be ready to establish the functions and configurations needed for the type(s) of the HOP requested by the customer (e.g., the hosting network operator). Basically, the HPIF 954 may be configured to perform the container preparation, the HMF instantiation and handover of the HOP container to the hosting network function HPCCF 952 with the required access keys.

6.29.3. HOP Creation Complete (Operation ready) Stage

In this stage, all the supporting functions and interfaces may be established and configured so that the HOP may be ready to create Digital Entities (D-XX) and support their operations. Once the HOP container is ready with the HMF 968, the HMF 968 may be configured to create and operate other functions needed for the HOP operation which includes Digital Entity (D-XX) creation and supporting D-XX operations and applications.

Note that, in above description, the second stage where the container is ready with the HMF is considered to be a basic HOP state. In this state the HOP may not be ready to provide services to Digital Entities (D-XX services) because the HOP may need additional functions and specific configurations to be able to instantiate a Digital Entity. For example, the additional functions required may depend on the type of the Digital Entities to support, on the services that the Digital Entities are to provide and on the level of trust, or confidentiality, the hosting operator may want to provide to the user. However, some of the common functions needed for any Digital Entity can be instantiated by the HPIF 954 when creating the HOP. Therefore, although the function of HPIF 954 may be configured to create the container with the HMF, in some implementations, the HPIF 954 may instantiate more functions before handing over the HOP to the HPCCF 952.

In some embodiments, after creating the basic HOP (e.g., with a HOP Manager, HPM), the creation of all the other functions and operations may be done by the HPM so that the HOP may operate independently from the hosting network. The HOP may be used for external customers or users to create DWs inside the hosting network. For example, a D-User may be required to control a home network, including working robots. Operations may need to be run by a home control application. A user may install home management applications in the D-User and may create other digital replicas of home devices (D-Reps) and configure the home management applications to meet the user requirements. Applications and data executed inside the D-User may not be visible to the hosting network.

In possible embodiments, however, the HPM may first need access permission from the hosting network (e.g., from HPCCF) to manage service-related control and data messages with the hosting network functions. HPM may take full control of its internal processes after this initial configuration. Any software needed and blueprints required may also be provided by the hosting network or the user.

### 6.30. HOP Creation Procedure

FIG. 10 illustrates an exemplary message flow for the HOP creation process 1000 and the different function modules involved. The following is an exemplary detailed description of the procedure.

### 6.30.1. Planning, Design and Preparation

In possible embodiments, the HOP creation process 1000 may start with a pre-preparation step where a Network Operator 1010, such as a Mobile Network Operator (MNO), determines the type of HOP that is to be created considering, for example:
The type of Digital Entity (e.g., D-User, D-Rep or D-Inf) and UCM services the network may provide;
Identifying whether the end user requires that the data and applications to be executed in the Digital Entity be kept confidential, i.e. whether the Hosting Network needs to be considered as a trusted network or not;
If services are to be provided to the user as an untrusted network, the level of privacy protection needed for the digital entity with regard to the hosting network may be determined.

Communications with a TEE vendor, such as a TEE manufacturer, to obtain the hardware or software required to create a confidential computing environment.

In possible embodiments, the HOP creation process may be triggered by a user requesting a D-User service while there is no HOP available. This is especially applicable to the case where a hosting network wants to create a separate HOP for each D-User. In that case, a user or a network function may request the creation of a D-User, which includes the creation of a HOP. However, whichever the case is, the creation process of HOP may remain the same.

The Network Operator may also update the latest blueprints of the HOP and the blueprints of Digital Entities (D-XX) types (e.g., D-User, D-Inf) that the network operator is planning to instantiate inside the HOP. The blueprints may be stored in a Blueprint Description Repository (BDR) managed by the Blueprint Management Function (BMF). Digital Entity (D-XX) blueprints may be standardized and may be defined by recognized standards or, in some cases, a network operator may control their own blueprints.

After the network operator 1010 determines the type of HOP to be created, the network operator may request (1040) the Infrastructure Service Management Function (ISMF) 1050, using service interface S0 (identified in FIG. 9), the required HOP type and any additional specifications related to the HOP, such as the type of container required for the HOP, including for example the need for TEE hardware and software. The request may also include the requirements for the Digital Entities (D-XX) to be created inside the HOP. The DE requirements may indicate the required capacity, which may be indicated as a number of Digital Entity instances of each D-XX type or total computing capacity, storage and internal and external link capacity. In addition, the request message may contain comprise the blueprints for the HOP and for the Digital Entities.

The ISMF 1050 may evaluate the resource requirements (1041) by obtaining resource availability for provisioning the required capacity, determining whether additional hardware needs to be acquired, such as TEE, including associated resources (e.g., computing resources, bandwidth requirements) and determining the capability of the network to provide the type of HOP requested. Then, the ISMF 1050 may identify the infrastructure for the HOP creation. This information may be provided to HPCCF 1052. In certain cases, HPIF 1070 may obtain information on available resources from the ISMF 1050.

Then, the ISMF 1050 may request the HPCCF 1052, using interface MP0 (identified in FIG. 9) to create the HOP (1042), using newly acquired hardware or internal infrastructure. The request message from the ISMF 1050 to the HPCCF 1052 may comprise the HOP blueprints and the potential D-XX blueprints and the resources to be used.

The HPCCF 1052 may verify the available blueprints (1043) from the BRMF 1058. The HPCCF 1052 may send the HOP requirements and the Digital Entity (D-XX) requirements to the BRMF 1058. If there are blueprints provided by the ISMF 1050, the blueprints may also be sent to the BRMF 1058.

Blueprints may be stored in the Blueprint Description Repository (BDR) and the BRMF 1058 may obtain the required blueprints (1044) according to the HOP request, from the BDR. The BRMF 1058 may query the BDR and send one or more blueprints to the HPCCF 1052 which match the HOP and D-XX requirements.

The HPCCF 1052 may choose or prepare a final set of blueprints (1045) to match the requirement of HOP.

The HPCCF 1052 may request the HPIF 1054 to instantiate and configure the HOP (1046). The HPCCF 1052 may provide the necessary blueprint details and other hosting network details.

The HPCCF 1052 may request the HPIF 1070 to create the HOP and instantiate the initial functions and interfaces the HOP requires to create and manage the Digital Entities. This step may comprise providing the finalized HOP blueprint to the HPIF. A list of initial functions may be provided to the HPIF which includes at least a HOP Network Function (HPFs), such as a HOP manager (HPM). It may also include other support functions, such as privacy preservation functions or LCM functions.

In some cases where 3rd party hardware may be used, i.e. hardware provided by suppliers other than the hosting network, the HPIF 1070 may communicate with external servers of the hardware supplier to obtain access codes to access and create the HOP (1047) with HPM functions. The HPIF 1070 may also create the interfaces with the hosting network functions such with the HPCCF 1052 and DXCF. The HPIF 1070 may also create additional support functions for the proper operation of the HOP.

The HPIF 1070 may pass access codes or separate access keys to the HPCCF 1052 so that the HPCCF can complete the HOP creation by deploying (or installing) other support functions and providing required configurations (1048). Alternatively, these additional functions may be created by the HPIF 1070.

If additional support functions are to be installed inside HOP, the HPCCF 1052 may request the HPM to create those functions. The HPCCF 1052 may configure the HPM and all the support functions and provide blueprints for different Digital Entities (D-XX) to the HPM. The HOP may also have an internal function orchestrator (HFO) to coordinate and manage functions inside HOP. Therefore, alternatively the HPCCF 1052 may pass the configuration parameters to the HPM and the HPM may configure the other support functions. Whether the HPM is allowed to do the internal function instantiation and configuration depends on how much knowledge the hosting network can have automatically after the creation. For some implementations, the hosting network may not be allowed to be aware of the internal configuration of the HOP. Adequate configuration according to the specifications is confirmed (1049) by each function individually or by the HPM.

The configuration of the HOP may also include establishing a secure link between the DXCF (identified in FIG. 9) and the HPM so that the DXCF can communicate with the HPM for the creation of Digital Entities (D-XX) inside the HOP. The Digital Entity creation request may first be received by the DXCF and then the DXCF communicates with the HPM to create the D-XX and establish a communication link between the UE of the operator of the D-XX and the D-XX. For example, when a user wants to create a D-User, the user request may reach the DXCF (in this case a DUCF) and the DUCF may facilitate the creation of the D-User and the establishment of a link between the user and the D-User.

The HPCCF 1052 may inform or notify the network operator or the hosting network service management layer of the completion of the HOP and that the HOP is now ready to be used (1051).

Operators or end-users may then request the creation of the Digital Entities (D-XX) (1053) and, after creation, they may use the services provided by the Digital Entities.

### 6.31. HOP Functional Architecture: Functional Description and Interfaces

FIG. 11 shows an exemplary functional architecture 1100 of a hosting platform 1108 showing details of the internal bus structure as well as platform creation functions of a hosting network 1104. Some of the functions, such as the ISMF 1150, the HIPF 1154, the DUCF 1166, the DSMF 1174 or the HPCCF 1152, are in the hosting network 1108, but outside the HOP 1108, and they may belong to various other XaaS services. The internal communications inside the HOP 1108 may be done by common C/M bus 1100 and DP bus 1112 as per the Service Based Architecture (SBA) architecture. The internal C/M and DP buses may be connected to the external buses through the HOP C/M GW 1114 and HOP DP GW 1116 respectively.

### 6.32. Functional Description: Functions Outside the HOP for HOP Creation

Under SBA architecture, a function may be described by the services it provides to its customers, the inputs required to provide the services and the associated outputs. Services may refer to software components or functionalities that provide specific capabilities or functionalities to users or other software modules. End users, or customers, may discover the service functions using, for example, a discovery function. The services may be limited to authorized end users. End users may be connected (via their UE) to the network functions 1170 providing the service using, for example, the internal C/M 1100 and DP 1112 buses. The functions not directly connected to the internal bus may be connected to using the GWs 1114, 1116, 1118. The reference points for the functions are marked in the diagram in the connection line to the bus, e.g., ISMF services 1150 are provided using N-C/M-ISMF reference point.

A description of the functions and their services are provided below.

### 6.32.1. ISMF (Infrastructure Service Management Function)

The ISMF 1150 may be used by a network operator to initiate the creation of an infrastructure service, in this case a HOP as a service. This function provides, allocates or identifies the infrastructure required to create a HOP for an end user. The infrastructure (hardware and/or software) for the HOP 1108 may be obtained from a 3rd party vendor, for the provisioning and configuration of an enclave, or in the network operator's own infrastructure. In certain cases, obtaining infrastructure from 3rd party vendors may be done at a later stage by HPIF 1157 after finalization of the overall resource requirement. A basic HOP management function description may need to be provided to the infrastructure vendor to prepare the HOP as a customized package that may include the HPFs needed to operate the HOP, create Digital Entities and/or provide services to Digital Entities. There may be additional functions that need to be included within the HOP to facilitate remote attestation of its contents. For example, once the HOP is created inside the hosting network, the hosting network may use the initial access keys to access the HOP and complete its configuration. When a Digital Entity (D-XX module) is created, the end user (owner or operator) of the Digital Entity may be allowed to prepare independent access keys to communicate with the service operator offering D-XX services and the service operator needs to attest authenticity of the Digital Entity. For example, isolation from the hosting network may need to be proved or certified by the hosting network. For this purpose, remote attestation keys may be generated from the Digital Entity (D-XX module) so that the service operator may verify the integrity of the Digital Entity with the infrastructure provider. This capability may be included in the initial enclave provided by the infrastructure provider. The customer may be the network operator in this case, as the HOP is required for the network operator. However, the service may be extended to an outside customer to create an in-network HOP for their user. For example, an external DW customer may need an in-network DW isolated from the network and that service (i.e., DWaaS) may be requested from the ISMF 1150.

ISMF services (provided using an N-C/M-ISMF reference point 1151) may include initiating the acquisition and allocation of infrastructure for the creation of a hosting platform for one or more of D-users, D-Reps, D-Infs or DWs as requested by an authorized service consumer giving the service requirements.

Potential service consumer examples include: Network operators, HPCCF, HPIF, a 3rd party wanting to create an isolated platform for an in-network DW, in-network D-Inf or any type of in-network D-Rep including D-Users.

### 6.32.2. HPCCF (HOP Creation and Configuration Function)

The HPCCF function 1152 can initiate the creation of a basic HOP 1108 by requesting the creation by the HPIF 1154 after obtaining infrastructure information from the ISMF 1150. After the creation of the basic HOP, the HPCCF 1152 may configure the HOP functions, change the access keys and instantiate more supporting functions according to a blueprint for that type of HOP. The HOP 1108 can be instantiated and configured by the HPCCF 1152, which may perform one or more of: managing resources of the HPFs relating to storing, processing and communications; creating the HPFs in the container; providing interfaces for the HPFs; and performing Life Cycle Management (LCM) of the HPFs inside the container according to a set of instructions.

HPCCF services may include:
Interpret the HOP service requirements, check available blueprints and finalize blueprints for execution by the HPIF;
Request the installation of a HOP after the required blueprints are finalized;
Send new blueprints to the BRMF to be saved in the BDR;
Configure the HOP Manager (HMF) and any other basic HOP function after creation of the HOP;
Request the HMF to instantiate internal functions required for D-XX module operation.

Potential service consumer examples may include: ISMF, BRMF, HOP-M.

### 6.32.3. HPIF (Hosting Platform Installation Function)

One of HPIF's 1154 main functionality may consist of installing the HOP 1168 and creating initial functions required according to the request from HPCCF 1152. The HPIF 1154 may be considered as the orchestrator of the hosting network 1104. The initial functions may include at least a HOP manager (HPM). They may also include other support functions such as privacy preservation functions of LCM functions.

Where hardware from vendors is used, the HPIF 1154 may have to contact the hardware vendor to obtain access codes to access and create the HOP with the functions required for the basic HOP. The basic HOP 1108 may consist of a HOP management function (HMF) 1168 which may include access control functions such as, for example, a C/M G/W function 1114, a database function 1120, a DP G/W function 1116 and an internal function orchestrator 1164. It may also create the related interfaces with the hosting network functions such as the HPCCF 1152 and the DUCF 1166. The HPIF 1154 may also create additional support functions.

The HPIF 1154 may pass the given access code or separate access keys to the HPCCF 1152 so that the HPCCF 1152 can complete the HOP creation by instantiating other support functions to create the intended Digital Entity (D-XX) 1106 and their operation and also configure them for the Digital Entity (D-XX) operations. Alternatively, creation of these additional functions may be done by the HPIF 1154 and the HPCCF 1152 may do the configuration of these additional functions.

Possible services of the HPIF 1154 may comprise:

Isolated enclave preparation: When a request to create a HOP as an isolated enclave is received, based on its policy and the requirements received in the creation request, the HPIF can decide what hardware may need to be obtained from a list of possible infrastructure solutions provided by the ISMF 1150 and it can obtain the infrastructure allocations to be used from the ISMF. If the ISMF 1150 has not acquired the infrastructure needed from an external vendor, the HPIF 1154 may instruct the purchasing department to obtain the HOP hardware required from the external vendor. Basic HOP management function description may need to be provided to the infrastructure vendor to prepare the HOP as a customized tool or package which can manage the HOP for the desired D-XX services.

For this purpose, the HPIF 1154 may receive a list of hardware vendors and their capabilities and the HOP requirements. After obtaining the hardware, the HPIF 1154 may install the hardware or activate the installed hardware and related ports as per a HOP blueprint or according to the requirement to create the isolated enclave.

After the isolated enclave is created, the HPIF 1154 may obtain security codes for accessing the internal HOP functions and create the HMF 1168 and other initial set of functions needed for the HOP creation according to the procedures given for the enclave.

When a request to create a HOP as a software container is received, the HPIF may instruct the hosting network orchestrator to create the HOP using the hosting network infrastructure and computing environment and allocate resources according to the requirement and acquire the management of the container.

When a request is received, the HPIF may provide a basic HOP to the HPCCF with established security keys for access where applicable.

Potential service consumer examples may comprise: the HPCCF, ISMF or the DUCF can be the functions that may request the creation of the HOP.

### 6.32.4. BRMF (Blueprint Description Repository (BDR) Management Function)

The BRMF 1158 function can manage the blueprint description repository 1156 (BDR). The BDR 1156 may contain blueprints of different HOP types and options and Digital Entity (D-XX) 1106 (e.g., D-users) that may be accessed using the BRMF 1158.

The services provided by the BRMF 1158 may comprise:

Update new HOP, Digital Entity (D-XX) blueprints, modify and terminate existing blueprints in the BDR.

Provide available matching blueprints when requested, optionally with HOP requirements.

Potential service consumer examples may comprise: HPCCF, HPM.

### 6.32.5. DUCF (D-User Creation Function)

The DUCF 1166 may arrange D-User creation when requested by a user, network entity or another D-Rep. A DUCF is a particular case of a DXCF.

The services of the DUCF 1166 may include the creation of a Digital Entity (in this case a D-User) inside a HOP following a request from HMF 1168. The D-User type to be created may be provided by the consumer.

The potential service consumer examples may comprise: a user, an authorized hosting network function (e.g., during the handover to a visiting network), the hosting network operator or an authorized 3rd party service provider.

### 6.33. Functions Inside HOP for HOP Operation and Summary of HOP Functionalities to Set Up with the HOP Platform Creation

The following are some of the functionalities which may be required inside the HOP. Different functions may be combined and implemented as one or more functional entities. For example, the HMF may take most of these responsibilities or spread the responsibilities across various individual functions. The following is an example categorization of the responsibilities.

### 6.33.1 HMF (HOP Management Function)

This control and management (C/M) function 1168 may provide the following services:

continuing the steps to complete the creation of HOP (creation and configuration of the supporting functions needed) after initial creation and configuration as a basic HOP (including an HMF function), and

continue to be involved in the operations of the HOP (creation of the Digital Entities (D-XX) and supporting their operation).

Certain Digital Entities (D-User or D-XX) 1106 may have a management function to take care of their own internal operations such as instantiation of other functions, LCM and resource allocation for them. In certain cases, the function instantiation inside a D-XX module 1106 and their LCM and resource allocation may be done by the HOP functions as well. For example, a D-User module 1106 may have a D-User manager so that it can take internal function instantiation and LCM. This may be important when the D-User management is fully done by the user. In that case, a HOP may be used exclusively for that D-User and the D-user manager is given the capability to create internal functions, do LCM and allocate resources.

The HMF 1168 may need to be configured by the HPCCF 1152 after it is created, in order for the HMF 1168 to take these actions. Some examples of the functionalities the HMF 1168 may execute are provided below. Some of these functionalities can be separate functions inside the HOP and whether these are handled by the HMF 1168 or a separate function is implementation dependent. For example, decision-making may be done based on the HOP AI function which would evaluate the actions and provide the recommendations or the evaluation results (e.g., prediction of the performance of an operation carried out by a D-XX module).

### 6.33.1.1. Creation of a Digital Entity (D-XX)

The creation of the Digital Entities (D-XX) 1106 and carrying out LCM may be the main function of the HMF 1168. The HMF 1168 may use internal function orchestrator 1164 (HFO) to create the Digital Entities 1106. If the HOP uses the hosting network infrastructure, the creation of D-XX modules is done by the hosting network's orchestrator based on a request from the HMF 1168. The requests in both cases may include the appropriate blueprints or essential components of the blueprint. The request may be received from the DUCF 1166 in the network or by the ISMF 1150. If an external host wants to have the ability to dynamically create Digital Entities (D-XX) 1106, such as D-Users, D-Reps or other types of D-XX, several D-XX of different types may be preinstalled and kept in a ready state, so that when a request is received, specific functions needed for the requested operation types are instantiated. The dynamic creation of these functions could be done by the HMF 1168.

The HMF 1168 may create D-XX 1106 with associated functions when a request is received from one of the hosting network functions, such as the DUCF 1166, the HPCCF 1152 or the ISMF 1150. The HMF 1168 may then use the internal function orchestrator (HFO) to create those modules when the HOP 1108 is provided with the capability of creating them inside the HOP (e.g., when independent operation is required). Otherwise, the hosting network functions HPCCF 1152 or HPIF 1154 would create those functional modules inside the HOP 1108. The functions required outside the HOP (i.e. software container or the enclave) may be created by the hosting network orchestrator or installer (i.e. the HPIF). The request may include a D-User type and the user access method and security keys to establish a communication link with the user. The creation of a D-User includes the creation of an isolated set of network functions and configuration of those functions and also the configuration of the common supporting functions that may be used for the D-User services inside the HOP or the hosting network. In some cases, D-User managing functions might create functions inside the D-User module instead of their creation by the HOP functions.

### 6.33.1.2. Instantiation of the Supporting Functions in the HOP and LCM

For the operation of the D-XX modules 1106, several supporting functions may be needed which may be instantiated when the HMF 1168 is created, or the HMF 1168 may instantiate them. If the hosting network infrastructure is used, the instantiation of other supporting functions and LCM may be done by the hosting network orchestrator.

For this purpose, the HMF 1168 may be provided with full capability to create functions inside the HOP and to do LCM, configure them, create GWs outside of the HOP, access control and privacy preservation functions for the D-XX modules 1106 and other supporting actions for the applications run in the HOP 1108 and D-XX modules 1106.

### 6.33.1.3. Configuration of the Supporting Functions

Once created, supporting functions may be configured to do the necessary actions according to the HOP blueprint. For example, one of the supporting functions inside the HOP may be the HOP Function Orchestrator (HFO) 1164 which may be capable of function creation inside the isolated container and of performing LCM. Another supporting function may include a privacy preserving portal (PPP) 1172, which may be configured based on the D-XX modules and their services the HOP needs to support. 6.34. Privacy Preserving Portals (PPP) and Access Control

To help ensure the privacy of the UE isn't leaked to the hosting network and vice versa, several PPP functions may be used, each having different objectives as indicated below.

6.34.1. Preserving UE Privacy without Exposing to the Host or to DN

One of the functions of the PPP 1172 may be to protect the UE/customer data from being exposed to a non-trusted hosting network. This function 1172 may be provided inside the D-user/D-XX 1106 or inside the HOP 1108. If a trusted executive (TEE) is used, this function may be placed outside the HOP. Employing PPP functions, such as a data filter, in the UE or the customer equipment, e.g., using Full Homomorphic Encryption (FHE) techniques, may limit the use of data for the data consumers. Therefore, the PPP 1172 may be provided inside the D-User/D-XX/HOP or in a secured location in the HN such that all the user queries, interests and other data may be shared only through this PPP. A PPP 1172 may have the following core modules:

### 6.34.1.1. Data Portal:

The Data Portal provides data processing functionality including, for example, data collecting, data distribution and policy application.

### 6.34.1.2. Crypto Suite

The Crypto Suite may provide privacy and security functionalities, including

FHE (Full Homomorphic Encryption) module which helps to achieve the privacy preserving query and other operations.

IDM (Identity Management) which may generate and manage a Pseudo-ID which represents the D-User/D-XX information. To ensure anonymity to the hosting network, there should be at least K number of D-Users/D-XX inside HOP as described in the K-anonymous requirement. For example, the K-anonymity model requirements can be used to anonymize user/customer communications to/from DNs (i.e., hosting network cannot know which user inside the HOP communicated with the DN). The K-Anonymity requirement can be summarized as “for every combination of identifying attributes in a dataset, there are at least “K minus 1” other people with the same attributes”. Therefore, the source ID may be changed with a randomized ID and also the return address to the user/customer may be randomized with a randomized location. These locations may change every time a location is used

### 6.34.2. Policy Engine

The Policy Engine may provide the updated access policy from the user and interacts with the Crypto Suite module and Data Portal to reflect the dynamics of the user.

### 6.35. Access Control and Authorization

The access to D-XX 1106 and HOP functions may be tightly controlled. Any incoming message may be first authenticated and then authorized if authentication has succeeded.

### 6.36. Blueprint Storage and the Storage Managing FUNCTION

A Digital Entity (D-XX) blueprint may be stored in this storage. Digital Entity blueprints describe the structure, configuration and the procedures on how to create and control a Digital Entity (D-XX) 1106 from the instantiation to the termination. Different Digital Entities (D-XX) 1106 have different features.

For example, a D-XX blueprint may comprise of one or more of:

User-ID, User IP address, D-User/D-XX type(s) supported (e.g., specific D-User/D-XX type or/and UCM service type(s), D-XX service types, D-Inf types and service types supported, X-R types supported).

The constituent functions required for each service the D-XX module supports for each D-XX type (e.g., UCM service types D-user support in a particular implementation).

A service establishment procedure for each service supported by a D-XX module (e.g., UCM service establishment procedure for each UCM service type for a D-user).

A service operation procedure for each service supported by a D-XX module (e.g., UCM service operation procedure for each UCM service type for a D-user).

Resource requirements for the D-User which include storage, computing and link capacities for different interfaces. Computing resources may include the number of CPUs or GPUs and their speeds and allocated % of CPU power from the computing engines and RAM memory requirements. Storage requirements may include storage size and access speeds.

The QoS characteristics (e.g., latency, packet loss, data rate, etc.) of the links between the D-XX module and the associated real entities such as users/customers, and the links between the D-XX module (such as a D-User module) and the network functions in the HOP or hosting network. (e.g., for a D-User, the link between D-User and the user, links from D-User to other network and HOP functions such as HPCCF, DUCF, ISMF.

### 6.37. Accounting and Invoicing Function

Invoicing D-XX services is carried out by this function. Invoicing (or charging) can be based on D-User service types or the amount of traffic used for these services or based on both criteria.

### 6.38. Common Database Manager (CDM)

The CDM 1120 controls access to the database. There may be a common database which is used by multiple Digital Entities (D-XX). These data areas may need to be isolated from each other and each D-XX may be given access only to data stored by that module. In addition, when data is stored outside the HOP in a common hosting network database, data transfer to and from the other database may be controlled by the CDM or by the HOP's DP GW.

### 6.39. Fault and Resilience Management Function

The fault and resilience management function may monitor the performance of each Digital Entity (D-XX) and, if any quality degradation or malfunctioning is noted, the function may provide the input to the HMF which may take appropriate action based on the decision maker input.

### 6.40. Performance Management Function

The performance management function may monitor the performance of the individual communication links supporting an operation of a D-XX service as well as the overall D-XX service delivery quality. If there is any performance degradation (e.g., expected performance such as overall delay is not met), an action may be taken to inform the D-XX manager and the HMF.

### 6.41. Resource Management Function

There can be a resource management function in the HOP as well as in each Digital Entity (D-XX). This may include monitoring and dynamic allocation of resources, including memory and bandwidth, to meet the Digital Entity's needs.

### 6.42. In-Network Processing Functions

There may be common in-network processing functions for standard types of processing needed for the Digital Entities (D-XX). If a Digital Entity is required to perform a specific type of processing, it might need to create the necessary functions within the module itself or the HOP may need to provide the D-XX with the required software to create those functions. AI functions, as discussed in the next section, may be considered as one type of processing. These AI functions could be a standard AI scheme or a specific type required by the Digital Entity. Similar to other processing functions, AI functions can be implemented either within a Digital Entity or within the HOP. The computing resources needed for processing functions may be specified in a Digital Entity blueprint. As the processing may be dynamic in nature, the computing resources may need to be adjusted.

### 6.43. Artificial Intelligence (AI) Functions

AI functions are specific type of processing function. AI functions may be available as common AI support functions inside the HOP or inside Digital Entities to prevent exposure of data used by the AI schemes to the hosting network. These AI functions can be used for many services including, for example:

User decision-making.

Support of a user's applications.

More efficient and improved running of various services (e.g., user home control, user mobility prediction, user interests tracking etc.).

In case of D-XX modules other than the D-User module, these modules may require more specific AI functions.

A method may need to be determined to train the AI functions described above.

### 6.44. Creation of an Isolated Container for a D-Rep (Representative) of a Generic Real Object

In some embodiments, a method to create a HOP in an isolated container inside a hosting network may be provided. The HOP may be for the creation of a digital representative of any real entity (D-Rep). A D-Rep may be created as a specific type of Digital Entity. Therefore, in this document, a D-Rep module is a particular case of a Digital Entity (D-XX). The real entity may be any physical object (e.g. a car, house, a road, etc.) A physical object may be owned, controlled or managed by another entity which is termed as the ‘customer’.

An in-network D-Rep can be used to provide many services to the real entity, which include, for example, in-network data storage, in-network data processing (e.g., run applications or specific network functions for evaluations, computing, data analysis and AI schemes), interacting with the hosting network to improve the communication services provided by the hosting network to the real entity, monitoring, obtaining network own data for its operations, controlling and managing the devices associated with the real entity and providing privacy for interactions with external application servers (e.g. data sharing, negotiations for agreements, financial transactions, content downloading, search engines, accessing the web sites).

The isolated container may be a software container in the hosting network computing platform using the hosting network hardware controlled, managed and orchestrated by the hosting network operator (HOP) in which case the hosting network needs to be sufficiently trustworthy for the operations the D-XX module carries out.

The isolated container may be created using an enclave created in a confidential computing environment, such as a TEE, which may be isolated from the hosting network. The enclave can create HOPs and do LCM of the functions inside the HOPs according to instructions provided. The instructions may be provided to the container's manager as a blueprint of the HOP wherein the blueprint may contain, for example:

The type(s) of D-Reps that may be created inside the HOP and their blueprints.

The steps or instructions to create a new type of module-Rep.

The common functions of the HOP and their configurations and associated processes.

The steps or instructions associated with the HMF after the HOP is created. For example, establishment of secure communication with the hosting network functions such as HPCCF, DUCF, DSMF and hosting network function discovery process including messaging structure, and ingress and egress ports, to use the hosting network C/M and DP bus.

The instructions or steps associated with the HOP managing function (HMF).

Resource requirements for the D-Rep which include storage, computing and link capacities for different interfaces. Computing resources may include the number of CPUs or GPUs and their speeds and allocated % of CPU power from the computing engines and RAM memory requirements. Storage requirement may include storage size and access speeds.

The QoS characteristics (e.g. latency, packet loss, data rate, etc.) of the links between the module-Reps and the associated real entities such as users, devices etc. The link requirements for the links between the expected D-Rep modules and the network functions in the HOP or hosting network.

The method to create a D-Rep may include identifying different privacy levels required by the D-Reps and associated technical solutions to provide these privacy levels.

The isolated HOP may have software to, for example:
create its own functions, and prepare interfaces according to blueprints provided to the HOP and do LCM for these functions,
download, install and configure computer programs, AI schemes and machine learning programs for the real entity to use, and
manage and control the network functions and allocate resources to various functions.

Methods to provide privacy may include one or more of:

Changing the ID of the real entity when interacting with external entities.

Encrypting and anonymizing the data of the real entity when moving out of the HOP.

Keeping HOP functions isolated from the hosting network by creating HOP inside a confidential computing environment or a TEE wherein the isolation may include:

Preventing the hosting network from accessing data inside the HOP.

Preventing the hosting network from accessing the functions inside the HOP without the D-Rep authorization.

Preventing the hosting network from identifying external entities a D-Rep may interact with by changing the ID of the real entity inside the HOP for outgoing data packets and providing a random location inside the HOP for external entities to provide responses.

The memory 604 may include any suitable type of non-transitory memory such as static random access memory (SRAM), dynamic random access memory (DRAM), synchronous DRAM (SDRAM), read-only memory (ROM), any combination of such, or the like. The mass storage element 602 may include any suitable type of non-transitory storage device, such as a solid-state drive, a hard disk drive, a magnetic disk drive, an optical disc drive, a USB drive, or any computer program product configured to store data and machine executable program code. According to certain embodiments, the memory 604 or the mass storage 602 may have recorded thereon statements and instructions executable by the processor 601 for performing any of the aforementioned method operations described above.

It will be appreciated that, although specific embodiments of the technology have been described herein for purposes of illustration, various modifications may be made without departing from the scope of the technology. The specification and drawings are, accordingly, to be regarded simply as an illustration of the application as defined by the appended claims, and are contemplated to cover any and all modifications, variations, combinations or equivalents that fall within the scope of the present application. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Actions associated with the method described herein can be implemented as coded instructions in a computer program product. In other words, the computer program product is a computer-readable medium (a tangible, non-transitory computer readable medium or memory) upon which software code (instructions) is recorded to execute the method when the computer program product is loaded into memory and executed on the microprocessor of a wireless communication device, or a network device, or a user equipment device.

Further, each operation of the method may be executed on any suitable computing device, such as a personal computer, server, personal digital assistant, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present application may be implemented by using hardware only or by using software and a universal hardware platform. Based on such understandings, the technical solution of the present application may be embodied in the form of a software product. The software product may be stored in a non-volatile or non-transitory storage medium, which can be a compact disk read-only memory (CD-ROM), USB flash disk, or a removable hard disk. The software product includes a number of instructions that enable a computer device (personal computer, server, or network device) to execute the methods provided in the embodiments of the present application. For example, such an execution may correspond to a simulation of the logical operations as described herein. The software product may additionally or alternatively include number of instructions that enable a computer device to execute operations for configuring or programming a digital logic apparatus in accordance with embodiments of the present application.

Although the present application has been described with reference to specific features and embodiments thereof, it is evident that various modifications and combinations can be made thereto without departing from the application. For example, although some embodiments of the disclosure provide for the VUE, instantiated inside the core network, the VUE may be instantiated inside RAN with similar functions in which case control plane and user plane functions used for the core network may be instantiated inside RAN with similar functionalities. The specification and drawings are, accordingly, to be regarded simply as an illustration of the application as defined by the appended claims, and are contemplated to cover any and all modifications, variations, combinations or equivalents that fall within the scope of the present application.

What is claimed is:

1. A method comprising:
receiving, at a Hosting Network Function (HNF) of a Hosting Network (HN), a request to create a Hosting Platform (HOP) to host one or more Digital Entities (DEs) requiring privacy for DE data and DE applications associated with the one or more DEs;
in response to the request, instantiating the HOP in a container inside the HN, the HOP including Hosting Platform Functions (HPFs); and
configuring the HOP and the HPFs, at least one of the HPFs allowing creation of a DE of the one or more DEs in the HOP, and allowing a real entity associated with the DE to access at least one of the DE data or the DE applications while preserving privacy of the real entity.

2. The method according to claim 1, wherein:
the DE data comprises parameters defining the DE as an entity and operational data associated with operations performed by the DE applications executed by the one or more DEs; and
the DE applications comprise at least one of: home network applications, AI schemes, user health applications, Virtual Reality (X-R) applications, infrastructure management applications, traffic control applications, data filtering, or data processing.

3. The method according to claim 1, wherein preserving privacy of the real entity is performed by at least one of:
preventing visibility of at least one of the real entity or the DE data;
processing of at least one of data of the real entity or the DE data; or
execution of specific functions of the real entity from any other entity using the HN or from any other external networks.

4. The method according to claim 1, wherein the HN is an untrusted network.

5. The method according to claim 4, wherein at least one HPF of the HPFs prevents the HN from accessing the DE data when the DE processes the DE data inside the HOP or when the DE shares the DE data with other entities external to the HN.

6. The method according to claim 5, wherein the at least one HPF prevents the HN from accessing the DE data by having the container instantiated in a Trusted Executive Environment (TEE), corresponding to a confidential computing environment (CCE) located inside the HN, the container being isolated from operating systems (OSs) of the HN.

7. The method according to claim 6, wherein the HOP is preconfigured to create the Hosting Platform Functions (HPFs) inside the TEE and to interact with the one or more DEs.

8. The method according to claim 6, wherein the container is an isolated container executed on hardware that is managed and controlled by the HN,
and wherein the container is protected by a cryptographic key, the method further comprising isolating the container from an OS managing the TEE, the cryptographic key being required to access the DE hosted in the HOP in the container.

9. The method according to claim 8, comprising:
receiving, at the container, an attestation request by a remote device; and
providing, by the container, the cryptographic key to the remote device based on a unique identifier of content or functionality of the container, to attest authenticity of the container.

10. The method according to claim 1, wherein instantiating and configuring the HOP is performed by a HOP Creation and Configuration Function (HPCCF), which performs one or more of:
creating the HPFs in the container;
providing interfaces for the HPFs;
managing resources of the HPFs relating to storing, processing, and communications; or
performing Life Cycle Management (LCM) of the HPFs inside the container according to a set of instructions.

11. The method according to claim 10, wherein different types of HOPs are associated with corresponding HOP blueprints, the HOP blueprints being stored in a Blueprint Description Repository (BDR) of the HN.

12. The method according to claim 10, wherein the HPFs comprise a HOP Manager Function (HMF) created inside the HOP, the HMF performing Life Cycle Management (LCM) of the one or more DEs, and managing communications between the one or more DEs and other entities.

13. The method according to claim 12, wherein the one or more DEs are created in the HOP by the HMF based on DE blueprints, the DE blueprints comprising at least one of:
creation instructions of the DEs, LCM of the DEs, DE operations, resource requirements, or Quality of Service (QoS) for messaging to and from the HPFs.

14. The method according to claim 10, comprising:
identifying, by at least one of the HNF or the HPFs, privacy levels required by the one or more DEs; and
implementing, by the HPFs, privacy techniques associated with the privacy levels.

15. The method according to claim 14, wherein the privacy techniques comprise at least one of:
changing an identifier of the one or more DEs when interacting with external entities;
encrypting the DE data exiting the HOP;
preventing a given DE from accessing data and internal functions of another DE without authorization from the other DE;
facilitating communications among the one or more DEs including using discovery methods, authentication methods and an authorization methods;
preventing the HN or HNF from accessing the DE data inside the HOP;
preventing the HN or HNF from accessing HPFs without authorization from the HPF responsible for access control; or
providing a random location inside the HOP for external entities to provide responses to requests from the one or more DEs.

16. The method according to claim 1, wherein one of the HPFs comprises a HOP Function Orchestrator (HFO) to instantiate additional HPFs inside the HOP.

17. The method according to claim 11, comprising determining a type of HOP that is to be instantiated, based on at least one of:
a DE type and associated DE services to be included and provided thereto;
requirement of the DE for a trusted or untrusted network; or
level of privacy required for an untrusted network.

18. The method according to claim 17, wherein instantiating the HOP comprises sending a message to an Infrastructure Service Management Function (ISMF) specifying at least one of:
a HOP category,
requirements for a TEE,
requirements for the HOP,
requirement for the one or more DEs to be hosted therein; or
blueprints for the HOP and for the DEs.

19. A Hosting Platform (HOP) for Digital Entities (DEs) digitally replicating real entities, the HOP comprising:
a Control and Management (C/M) plane function module comprising at least one of:
a C/M gateway for controlling incoming and outgoing messages of the C/M plane function module;
a C/M plane privacy preserving portal (PPP);
a HOP manager function (HMF);
a HOP internal function orchestrator (HFO); or
Common C/M network functions (NFs) for supporting DE operations; and
a Data Plane (DP) functions module comprising at least one of:
a common database,
a PPP; or
Hosting Platform Functions (HPFs) to support DE operations.

20. A system allowing a Host Network (HN) to provide a confidential digital environment to a real entity for applications of the real entity, the system comprising:
one or more processors; and
at least one tangible, non-transitory memory storing instructions that, when executed by the one or more processors, cause the system to:
provide a Hosting Platform (HOP) in a container of the HN, the HOP being created, configured, and managed by the HN, wherein:
the HOP is configured to allow the real entity to create a digital entity (DE) representing the real entity inside the HOP upon receiving a request from the real entity;
the DE comprises at least one DE function and corresponding resources to execute the at least one DE function; and
the HN controls and manages communications between the DE and the real entity, and between the DE and other entities external to the HN to ensure privacy of the communications.
